(19) United States
(12) Patent Application Publication
(10) Pub. No.: US 2024/0001695 A1
(43) Pub. Date: Jan. 4, 2024

(54) PRINTING DEVICE AND PRINTING METHOD

(71) Applicant: SEIKO EPSON CORPORATION, Tokyo (JP)

(72) Inventor: Hiroyuki USHIAMA, Chino (JP)

(21) Appl. No.: 18/346,282

(22) Filed: Jul. 3, 2023

(30) Foreign Application Priority Data
Jul. 4, 2022 (JP) 2022-107515

(51) Int. Cl. B41J 25/00; B41J 2/21

(52) U.S. Cl. CPC B41J 25/001; B41J 2/21

(57) ABSTRACT

A recording head includes a plurality of color nozzle groups in which the colors of color ink droplets ejected in a forward path and in a return path in bidirectional printing are different from each other with respect to a band region. A compensation section forms a reference patch on the recording medium by ejecting the first and second color ink droplets in a predetermined recording density ratio at a reference timing difference with respect to an ejection timing difference between first color ink droplets from a first color nozzle group and second color ink droplets from a second color nozzle group, which are generated depending on the position in the band region in the main scanning direction, forms a plurality of first patches on the recording medium by ejecting the first and second color ink droplets in a plurality of different recording density ratios at a first timing difference, and compensates for the color shift due to the timing difference based on a recording density ratio corresponding to a first color shift compensation patch selected from the plurality of first patches to form a print image.

The present application is based on, and claims priority from JP Application Serial Number 2022-107515, filed Jul. 4, 2022, the disclosure of which is hereby incorporated by reference herein in its entirety.

### BACKGROUND

### 1. Technical Field

The present disclosure relates to a printing method and to a printing device of performing main scanning and sub-scanning.

### 2. Related Art

A serial printer performs printing by ejecting ink droplets from a recording head onto a recording medium while performing main scanning in which the recording head is moved back and forth along a main scanning direction, and performs sub-scanning in which the recording medium is fed in a feeding direction while printing is not being performed. The feed direction is opposite to the sub-scanning direction, which is the relative movement direction of the recording head. In bidirectional printing, ink droplets are ejected from the recording head onto the recording medium in both forward and return passes during main scanning.

In JP-A-2011-5875, there is shown a “vertical array head”, which is a recording head having a color nozzle row in which a yellow nozzle group, a magenta nozzle group, and a cyan nozzle group are aligned in a single line in a sub-scanning direction. The vertical array head has a black nozzle row parallel to a color nozzle row. The length of each color nozzle group of the color nozzle row in the sub-scanning direction is ⅓ of the length of the black nozzle row. Since the vertical array head requires only two nozzle rows, it can be formed at a low cost, and high-speed monochrome printing can be realized by using a black nozzle row having a length three times the length of each color nozzle group.

When performing high-speed bidirectional band printing at the time of color printing, of the plurality of band regions corresponding to the length of each color nozzle group, a serial printer including the vertical array head described above ejects magenta ink droplets in the return path into band regions where cyan and yellow ink droplets are ejected in the forward path. In addition, cyan and yellow ink droplets are ejected in the forward path into the band region where magenta ink droplets are ejected in the return path.

It was found that coloring in the printed image formed in the above-described band region differs depending on the position in the main scanning direction. Therefore, there is a demand for a countermeasure against color unevenness in which coloring differs depending on the position in the main scanning direction at the time of color bidirectional printing with a vertical array head.

### SUMMARY

A printing device according to an aspect of the disclosure includes a recording head including a black nozzle row in which a plurality of black nozzles for ejecting black ink droplets are aligned and a plurality of color nozzle groups in which a plurality of color nozzles for ejecting color ink droplets are aligned along the black nozzle row, the color nozzle groups being aligned in order in an alignment direction of the plurality of black nozzles; a drive section configured to perform main scanning in which a relative position between the recording head and the recording medium is changed in a forward path and a return path along a main scanning direction, which intersects the alignment direction, and to perform sub-scanning in which the relative position between the recording head and the recording medium is changed along a sub-scanning direction, which intersects the main scanning direction; and a control section configured to control bidirectional printing in which color ink droplets are deposited on the recording medium in both the forward path and in the return path of one main scanning between sub-scannings, from the color nozzle groups allocated to band regions, which correspond to lengths in the sub-scanning direction of the color nozzle groups that eject the color ink droplets, wherein the plurality of color nozzle groups includes a first color nozzle group and a second color nozzle group in which colors of the color ink droplets ejected to a band region in the forward path and in the return path in the bidirectional printing are different from each other, the color ink droplets ejected by the first color nozzle group are referred to as first color ink droplets and the color ink droplets ejected by the second color nozzle group are referred to as second color ink droplets, the control section includes a compensation section that compensates for a color shift due to a timing difference between ejection of the first color ink droplets and ejection of the second color ink droplets that occurs depending on a position in the main scanning direction in the band region, and the compensation section is configured to form a reference patch on the recording medium by ejecting the first color ink droplets and the second color ink droplets in a predetermined recording density ratio at a reference timing difference, which is a reference for the timing difference, form a plurality of first patches on the recording medium by ejecting the first color ink droplets and the second color ink droplets in a plurality of different recording density ratios at a first timing difference that is different from the reference timing difference, and form a print image after compensating for the color shift due to the timing difference, wherein the compensation is based on a recording density ratio that corresponds to a first color shift compensation patch that was selected from the plurality of first patches.

Also, a printing method of the present disclosure includes an aspect for printing using a printer including a recording head including a black nozzle row in which a plurality of black nozzles ejecting black ink droplets are aligned and a plurality of color nozzle groups in which a plurality of color nozzles ejecting color ink droplets are aligned along the black nozzle row, the plurality of color nozzle groups being aligned in order in an alignment direction of the plurality of black nozzles and a drive section configured to perform main scanning in which a relative position between the recording head and the recording medium is changed in a forward path and a return path along a main scanning direction, which intersects the alignment direction, and to perform sub-scanning in which the relative position between the recording head and the recording medium is changed along a sub-scanning direction, which intersects the main scanning direction, wherein the printing method is for bidirectional printing in which color ink droplets are deposited on the recording medium in both the forward path and in the return path of one main scanning between sub-scannings, from the color nozzle groups allocated to band regions, which correspond to lengths in the sub-scanning direction of the color nozzle groups that eject the color ink droplets, the plurality of color nozzle groups include a first color nozzle group and a second color nozzle group in which colors of the color ink droplets ejected to a band region in the forward path and in the return path in the bidirectional printing are different from each other, and the color ink droplets ejected by the first color nozzle group are referred to as first color ink droplets, and the color ink droplets ejected by the second color nozzle group are referred to as second color ink droplets, the printing method comprising: a reference patch formation step of forming a reference patch on the recording medium by ejecting the first color ink droplets and the second color ink droplets in a predetermined recording density ratio at a reference timing difference, which is a reference of an ejection timing difference between the first color ink droplets and the second color ink droplets that occurs depending on a position in the main scanning direction in the band region; a first patch formation step of forming a plurality of first patches on the recording medium by ejecting the first color ink droplets and the second color ink droplets in a plurality of different recording density ratios at a first timing difference, which is different from the reference timing difference; and a print image formation step of forming a print image after compensating for the color shift due to the timing difference, wherein the compensation is based on a recording density ratio that corresponds to a first color shift compensation patch that was selected from the plurality of first patches.

### BRIEF DESCRIPTION OF THE DRAWINGS

FIG. 1 is a diagram schematically illustrating an example of a printing device.

FIG. 2 is a diagram schematically illustrating an example of a nozzle surface of a recording head and a dot pattern on a recording medium.

FIG. 3 is a plan view for schematically explaining an example of color bidirectional band printing.

FIG. 4 is a diagram schematically illustrating an example of an adjustment pattern, which includes a reference patch, a first patch, and a second patch.

FIG. 5 is a diagram schematically illustrating an example of forming conditions of patches included in a mixed color adjustment pattern of cyan and magenta.

FIG. 6 is a diagram schematically illustrating an example of forming conditions of patches included in a mixed color adjustment pattern of magenta and yellow.

FIG. 7 is a diagram schematically illustrating an example of calculating a correction value according to a timing difference Ti of ink droplet ejection.

FIG. 8 is a diagram schematically illustrating an example of generating a color conversion LUT as correction data.

FIG. 9 is a diagram schematically illustrating an example of generating a dot generation LUT as correction data.

FIG. 10 is a flowchart schematically illustrating an example of a correction data generation process.

FIG. 11 is a flowchart schematically illustrating an example of a print control process.

FIG. 12 is a diagram schematically illustrating an example of forming a printed image by color bidirectional band printing.

FIG. 13 is a flowchart schematically illustrating an example of a color shift compensation process using a color conversion LUT.

FIG. 14 is a flowchart schematically illustrating an example of a color shift compensation process using a dot generation LUT.

FIG. 15 is a flowchart schematically illustrating an example in which whether or not to generate correction data is switched in accordance with the type of printing medium.

FIG. 16 is a diagram schematically illustrating an example in which a color shift occurs in accordance with a timing difference T of ink droplet ejection.

### DESCRIPTION OF EMBODIMENTS

Hereinafter, embodiments of the present disclosure will be described. Of course, the following embodiments merely exemplify the present disclosure, and all of the features shown in the embodiments are not necessarily essential to the solutions in the present disclosure.

### (1) Summary of Technology Included in the Present Disclosure

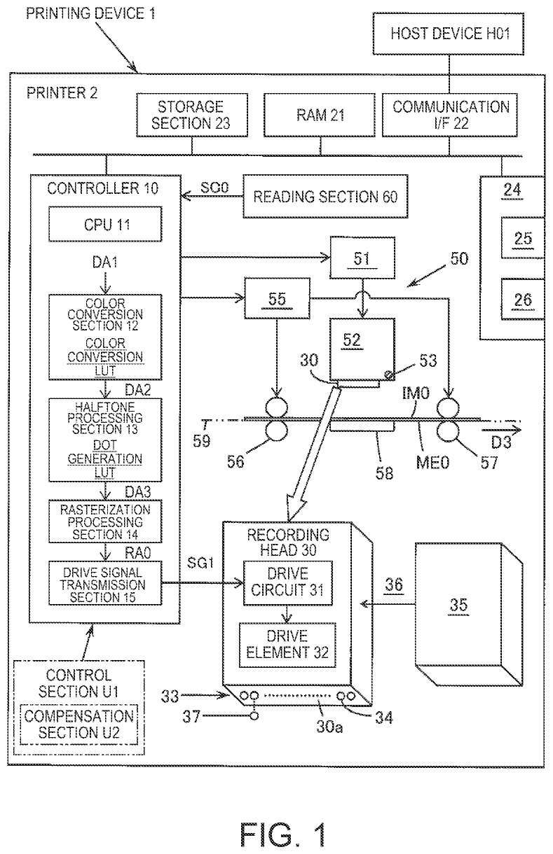

First, an outline of technology included in the present disclosure will be described with reference to examples shown in FIGS. 1 to 16. Note that the drawings of the present application are diagrams that schematically illustrate examples, and the enlargement ratios in the respective directions illustrated in these drawings may be different, and the respective drawings may not match. As a matter of course, each element of the present technology is not limited to specific examples indicated by reference numerals. In the “Summary of technology included in the disclosure”, parentheses refer to a supplementary explanation of the immediately preceding word.

### Aspect 1

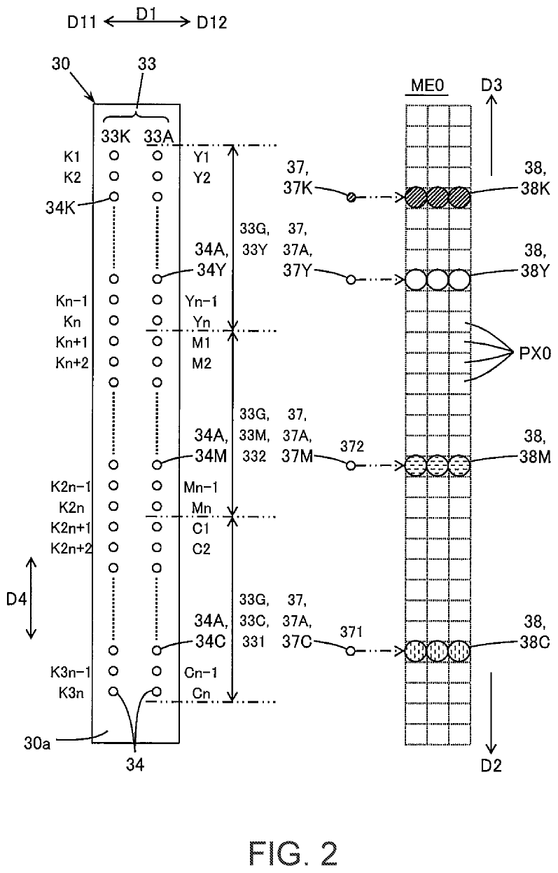

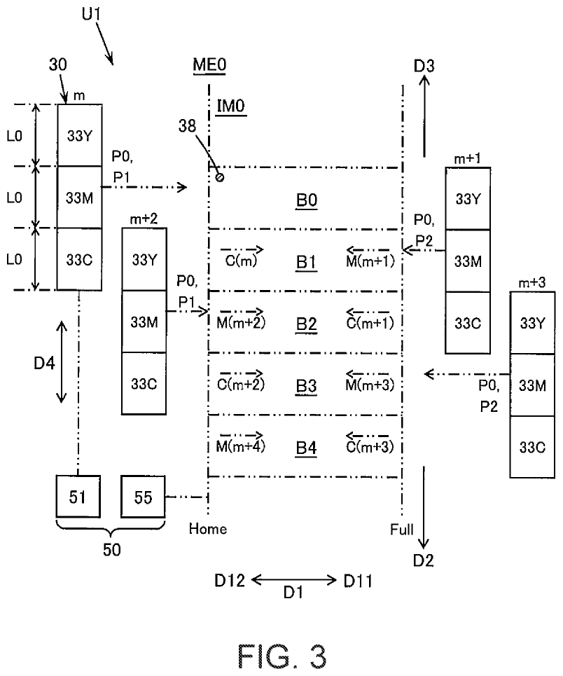

As shown in FIG. 2, a printing device 1 according to an aspect of the present technology includes a recording head 30 having a black nozzle row 33K in which a plurality of black nozzles 34K ejecting black ink droplets 37K are aligned, and a plurality of color nozzle groups 33G in which a plurality of color nozzles 34A ejecting color ink droplets 37A are aligned along the black nozzle rows 33K. The color nozzle groups 33G are aligned in order in the alignment direction D4 of the plurality of black nozzles 34K. As shown in FIG. 1, the printing device 1 includes a drive section 50 and a control section U1. As shown in FIG. 3, the drive section performs a main scanning P0 in which the relative position between the recording head 30 and the recording medium ME0 changes in a forward path P1 and a return path P2 along a main scanning direction D1, which intersects the alignment direction D4, and performs a sub-scanning in which the relative position between the recording head 30 and the recording medium ME0 changes along a sub-scanning direction D2, which intersects the main scanning direction D1. The control section U1 controls bidirectional printing in which the color ink droplets 37A are deposited on the recording medium ME0 in both the forward path P1 and the return path P2 in one main scanning P0 between the sub-scans from the color nozzle groups 33G assigned to the band regions B0, which correspond to the lengths L0 in the sub-scanning direction D2 of the color nozzle groups 33G, which eject color ink droplets 37A. The plurality of color nozzle groups 33G include a first color nozzle group 331 and a second color nozzle group 332 in which colors of the color ink droplets 37A ejected to the band region B0 in the forward path P1 and in the return path P2 in the bidirectional printing are different from each other.

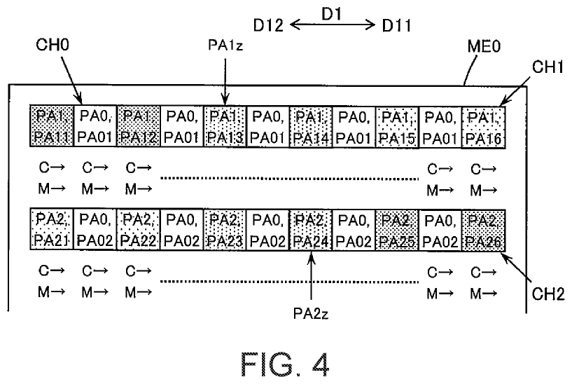

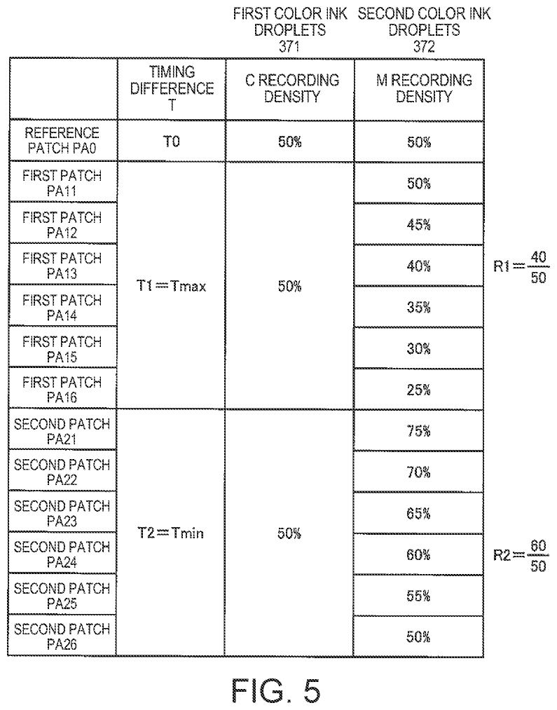

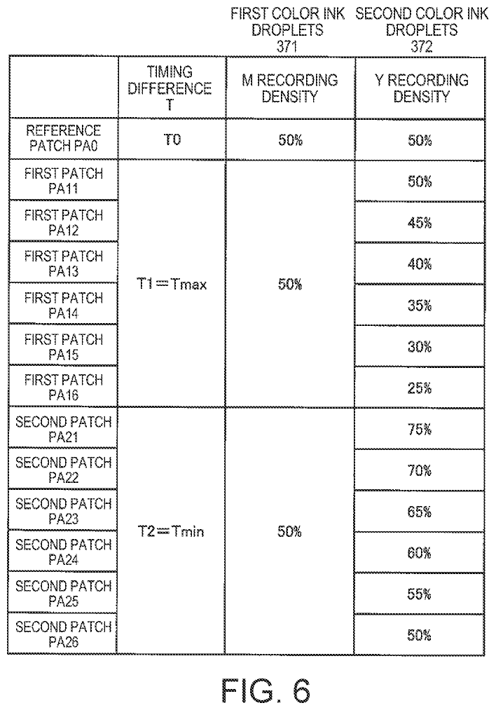

As shown in FIGS. 5 and 6, the color ink droplets 37A ejected by the first color nozzle group 331 are referred to as first color ink droplets 371, and the color ink droplets 37A ejected by the second color nozzle group 332 are referred to as second color ink droplets 372. The control section U1 includes a compensation section U2 (refer to FIG. 1) that compensates for a color shift due to a timing difference T, between ejection of the first color ink droplets 371 and ejection of the second color ink droplets 372, that occurs depending on the position X in the main scanning direction D1 in the band region B0. The compensation section U2 performs the following processes as shown in FIGS. 4, 10, 11 and the like.

Process 1: The compensation section U2 forms reference patches PA0 on the recording medium ME0 by ejecting the first color ink droplets 371 and the second color ink droplets 372 in a predetermined recording density ratio at a reference timing difference T0, which is a reference of the timing difference T.

Process 2: The compensation section U2 forms a plurality of first patches PA1 on the recording medium ME0 by ejecting the first color ink droplets 371 and the second color ink droplets 372 in a plurality of different recording density ratios at a first timing difference T1, which is different from the reference timing difference T0.

Process 3: The compensation section U2 forms a print image IM0 after compensating for the color shift caused by the timing difference T, wherein the compensation is based on a recording density ratio R1, which corresponds to a first color shift compensation patch PA1z that was selected from the plurality of first patches PA1.

The reference patch PA0 indicates a print color when the timing difference T between the ejection of the first color ink droplets 371 and the ejection of the second color ink droplets 372 is the reference timing difference T0. The plurality of first patches PA1 indicate candidates of correction colors wherein the timing difference T of ink droplet ejection differs from the reference timing difference T0. When the first color shift compensation patch PA1z is selected from the plurality of first patches PA1, the color shift due to the timing difference T is compensated based on the recording density ratio R1 corresponding to the first color shift compensation patch PA1z.

As described above, the above-described aspect can provide a printing device capable of reducing color unevenness caused by the vertical array head.

Here, changing the relative position between the recording head and the print medium means changing the relative positional relationship between the recording head and the print medium. Changing the relative position between the recording head and the recording medium includes moving the recording head without moving the recording medium, moving the recording medium without moving the recording head, and moving both the recording head and the recording medium.

In the present application, “first”, “second”, and so on are terms for identifying each component included in a plurality of components having similarities, and do not mean an order.

Note that the above-described additional remarks are also applied to the following aspects.

### Aspect 2

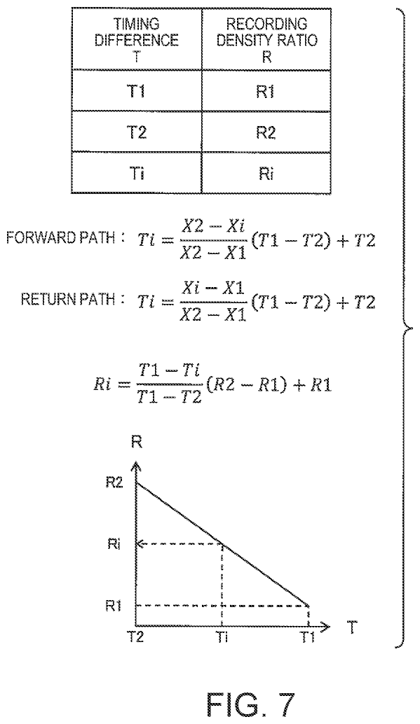

As shown in FIGS. 5 and 6, the first timing difference T1 may be larger than the reference timing difference T0. The compensation section U2 may form a plurality of second patches PA2 on the recording medium ME0 by ejecting the first color ink droplets 371 and the second color ink droplets 372 in a plurality of different recording density ratios at a second timing difference T2, which is smaller than the reference timing difference T0. As shown in FIGS. 7, 10, 11, and the like, the compensation section U2 may form the print image IM0 by compensating for the color shift caused by the timing difference T based on the recording density ratio R1 corresponding to the first color shift compensation patch PA1z and the recording density ratio R2 corresponding to the second color shift compensation patch PA2z that was selected from the plurality of second patches PA2.

The plurality of first patches PA1 indicate candidates of correction color when the timing difference T of ink droplet ejection is larger than the reference timing difference T0. The plurality of second patches PA2 indicate candidates of correction color when the timing difference T of ink droplet ejection is smaller than the reference timing difference T0. When the first color shift compensation patch PA1z is selected from the plurality of first patches PA1 and the second color shift compensation patch PA2z is selected from the plurality of second patches PA2, the color shift due to the timing difference T is compensated for based on the recording density ratio R1 corresponding to the first color shift compensation patch PA1z and the recording density ratio R2 corresponding to the second color shift compensation patch PA2z.

As described above, the above-described aspect can provide a printing device capable of further reducing color unevenness caused by the vertical array head.

### Aspect 3

As shown in FIG. 4, the compensation section U2 may form, as the reference patches PA0, first reference patches PA01 disposed on the recording medium ME0 between first patches PA1 and second reference patches PA02 disposed on the recording medium ME0 between the second patches PA2.

In this case, since the first reference patches PA0l are arranged between the first patches PA1, it is possible to easily select the first color shift compensation patch PA1z from the plurality of first patches PA1, and since the second reference patches PA02 are arranged between the second patches PA2, it is possible to easily select the second color shift compensation patch PA2z from the plurality of second patches PA2. Therefore, the above-described aspect can provide a printing device capable of easily reducing color unevenness caused by the vertical array head.

### Aspect 4

As shown in FIG. 4, the compensation section U2 may perform control such that the ejections of the first color ink droplets 371 and the second color ink droplets 372 for forming the reference patches PA0 on the recording medium ME0 are aligned with one of either the forward path P1 or the return path P2.

By the above, the reference patch PA0 indicating the print color at the reference timing difference T0 of ink droplet ejection is formed with high accuracy. Therefore, the above aspect can provide a desirable example of forming the reference patch.

### Aspect 5

As shown in FIG. 4, the compensation section U2 may perform control such that ejections of the first color ink droplets 371 and the second color ink droplets 372 for forming the plurality of first patches PA1 and the plurality of second patches PA2 on the recording medium ME0 are aligned with one of either the forward path P1 or the return path P2.

As described above, the plurality of first patches PA1 indicating the candidates of the correction color for the first timing difference T1, which is larger than the reference timing difference T0, are formed with high accuracy, and the plurality of second patches PA2 indicating the candidates of the correction color in the second timing difference T2, which is smaller than the reference timing difference T0, are formed with high accuracy. Therefore, the above aspect can provide a desirable example of forming a plurality of first patches and a plurality of second patches.

### Aspect 6

As shown in FIGS. 5 and 6, the first timing difference T1 may be a maximum Tmax of the timing difference T in the bidirectional printing. The second timing difference T2 may be a minimum Tmin of the timing difference T in the bidirectional printing.

In the above case, the plurality of first patches PA1 indicate candidates of the correction color when the timing difference T of ink droplet ejection is the maximum Tmax. The plurality of second patches PA2 indicate candidates of the correction color when the timing difference T of ink droplet ejection is the minimum Tmin. Therefore, the above-described aspect can provide a printing device capable of further reducing color unevenness caused by the vertical array head.

### Aspect 7

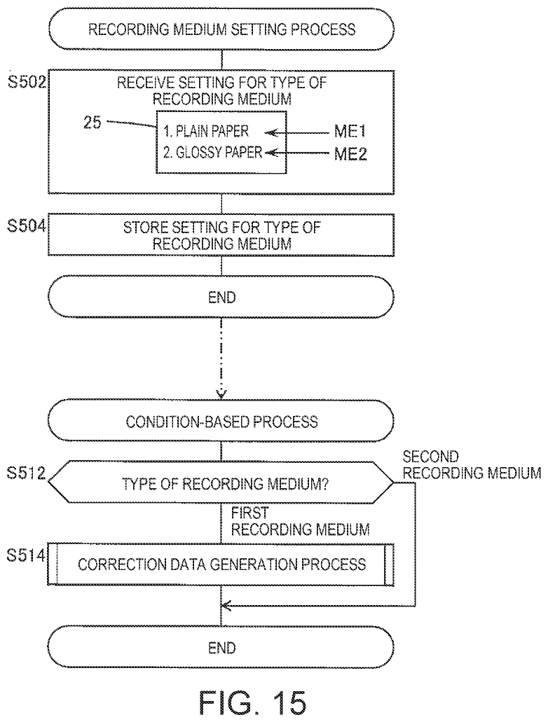

As shown in FIG. 15, the recording medium ME0 may include a first recording medium ME1 and a second recording medium ME2, which has a smaller color shift due to the timing difference T than does the first recording medium ME1. The control section U1 may receive setting of a type of the recording medium ME0 on which the print image IM0 is to be formed. When the type corresponds to the first recording medium ME1, the control section U1 may form the print image IM0 after compensating, in the compensation section U2, for the color shift due to the timing difference T. When the type corresponds to the second recording medium ME2, the control section U1 may not perform the process of compensating for the color shift due to the timing difference T.

In this case, when the color shift due to the timing difference T of ink droplet ejection is small, it is not necessary to perform the process of compensating for the color shift. Therefore, the above-described aspect can improve convenience for the user.

### Aspect 8

The compensation section U2 may acquire the reading results SC0 of the reference patch PA0 and of the plurality of first patches PA1, and select the first color shift compensation patch PA1z from the plurality of first patches PA1 based on the reading results SC0. In this aspect, since the color shift compensation patch for compensating the color shift due to the timing difference T of ink droplet ejection is automatically selected, it is possible to improve convenience for the user.

### Aspect 9

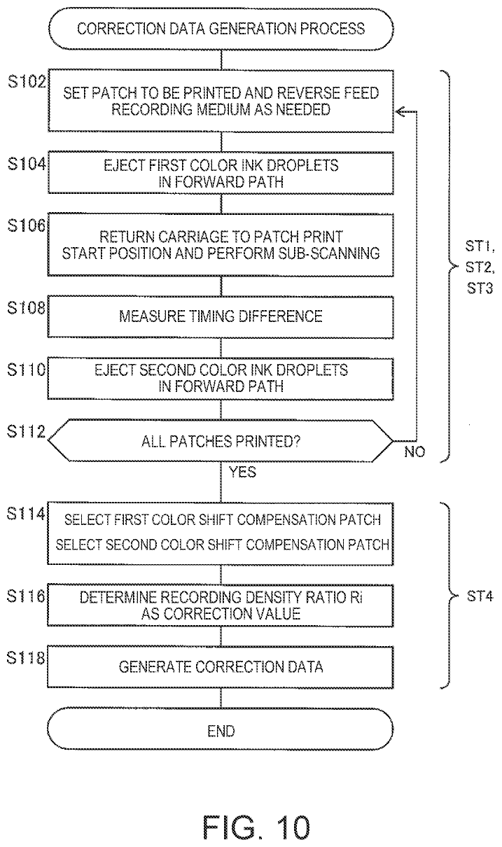

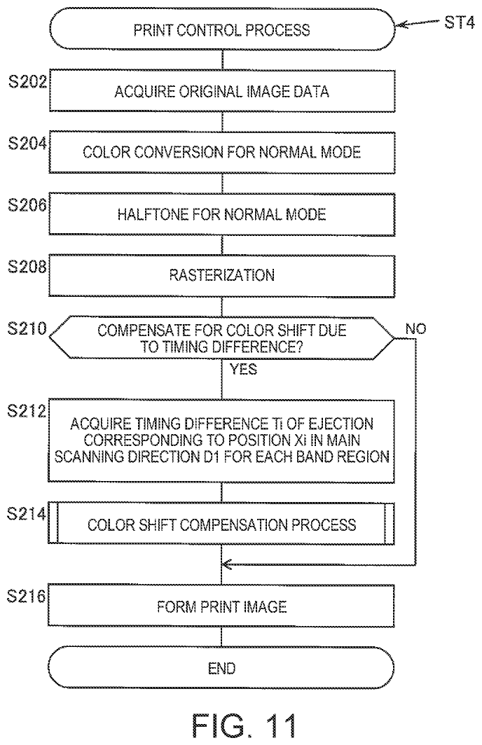

Note that, as shown in FIGS. 10, 11, and the like, a printing method according to an aspect of the present technology includes the following steps.

(A1) A reference patch formation step ST1 of forming a reference patch PA0 on the recording medium ME0 by ejecting first color ink droplets 371 and second color ink droplets 372 at a predetermined recording density ratio at a reference timing difference T0, which is a reference of a timing difference T between ejections of the first color ink droplets 371 and the second color ink droplets 372 generated depending on a position X in the band region B0 in the main scanning direction D1.

(A2) A first patch formation step ST2 of forming a plurality of first patches PA1 on the recording medium ME0 by ejecting the first color ink droplets 371 and the second color ink droplets 372 in a plurality of different recording density ratios at a first timing difference T1 different from the reference timing difference T0.

(A3) A print image formation step ST4 of forming a print image IM0 after compensating for the color shift due to the timing difference T, based on a recording density ratio R1, which corresponds to a first color shift compensation patch PA1z that was selected from the plurality of first patches PA1.

The above-described aspect can provide a printing method capable of reducing color unevenness caused by a vertical array head.

Furthermore, the present technology can be applied to a printing system including the above-described printing device, a control method of the printing system, a control program of the above-described printing device, a control program of the above-described printing system, a computer-readable medium storing any one of the above-described control programs, and the like. Further, the printing device described above may be constituted by a plurality of distributed parts.

### (2) Specific Example of Printing Device

FIG. 1 schematically illustrates a printing device 1. The printing device 1 includes a control section U1 including a compensation section U2. Although the printing device 1 in this example is the printer 2 itself, the printing device 1 may be a combination of the printer 2 and the host device HO1. Note that the printer 2 may include additional elements not shown in FIG. 1. FIG. 2 schematically illustrates the nozzle surface 30a of the recording head 30 and a dot pattern on the recording medium ME0. FIG. 3 is a plan view schematically illustrating color bidirectional band printing.

The printer 2 shown in FIG. 1 is a serial printer, which is a type of ink jet printer, and includes a controller 10, a RAM 21, which is a semiconductor memory, a communication I/F 22, a storage section 23, an operation panel 24, a recording head 30, a drive section 50, and the like. Here, RAM is an abbreviation of random access memory, and I/F is an abbreviation of interface. The printer 2 may include a reading section 60 that reads an image such as the adjustment pattern CH0 shown in FIG. 4. The reading section 60 shown in FIG. 1 is connected to the controller 10, and outputs image reading results SC0 to the controller 10. The printer 2 may include a colorimeter that measures the color of the patch.

The controller 10, the RAM 21, the communication I/F 22, the storage section 23, and the operation panel 24 are connected to a bus, and can input and output information to and from each other.

The controller 10 includes a CPU 11, which is a processor, a color conversion section 12, a halftone processing section 13, a rasterization processing section 14, the drive signal transmission section 15, and the like. Here, CPU is an abbreviation of central processing unit. The controller 10 controls main scanning and sub-scanning by the drive section 50 and ejection of the ink droplets 37 by the recording head 30 based on the original image data DA1 acquired from the host device HO1, a memory card (not shown), and the like. The original image data DA1 may be any image that can be converted into the ink amount data DA2, for example, RGB having integer values of 2⁸ gradations or 2¹⁶ gradations of R, G, and B can be applied to each pixel. Here, R means red, G means green, and B means blue. The controller receives setting of a print mode from any one of the host device HO1, the operation panel 24, and the like, and controls main scanning and sub-scanning by the drive section 50 and ejection of the ink droplets 37 by the recording head 30 in accordance with the set print mode. The print mode includes a mode for performing color printing, a mode for performing monochrome printing, a mode for performing bidirectional printing, a mode for performing unidirectional printing, a mode for performing band printing, a mode for performing interlace printing, and the like.

The controller 10 can be configured by an SoC or the like. Here, SoC is an abbreviation of system on a chip.

The CPU 11 is a device that mainly performs information processes and controls in the printer 2.

For example, the color conversion section 12 refers to a color conversion LUT in which a correspondence relationship between gradation values of R, G, and B and gradation values of C, M, Y, and K is defined, and converts the RGB data into ink amount data DA2 having integer values of 2⁸ or 2¹⁶ gradations of C, M, Y, and K in each pixel. Here, C means cyan, M means magenta, Y means yellow, K means black, and LUT is an abbreviation of lookup table. The ink amount data DA2 represents the use amount of the ink 36 per pixel PX0 unit. When the resolution of the RGB data is different from the output resolution, the color conversion section 12 converts the resolution of the RGB data into output resolution and converts the converted RGB data into ink amount data DA2. Since it is sufficient that in the end the ink amount data DA2 of the output resolution can be generated from RGB data, the color conversion section 12 may generate, from the RGB data, ink amounts DF having the resolutions of the RGB data, and then generate the ink amount data DA2 by converting the resolutions of the ink amount data DA2 into the output resolution.

The halftone processing section 13 performs a predetermined halftone process, such as a dithering, error diffusion, or a density pattern method, on the gradation value of each pixel PX0 constituting the ink amount data DA2 in order to reduce the number of gradations in the gradation values and generate halftone data DA3. The halftone data DA3 represents the formation state of the dots 38 per pixel PX0 unit. The halftone data DA3 may be binary data representing the presence or absence of dot formation, or may be multi-valued data of three or more gradations that can correspond to dots of different sizes such as small, medium, and large dots. The binary data can be, for example, data in which 1 corresponds to dot formation and 0 corresponds to no dot. As four-value data, which can be expressed by two bits for each pixel, data can be used in which, for example, 3 corresponds to formation of a large dot, 2 corresponds to formation of a medium dot, 1 corresponds to formation of a small dot, and 0 corresponds to no dot.

The rasterization processing section 14 generates raster data RAO by performing a rasterization process of rearranging the halftone data DA3 in the order in which the dots 38 are formed by the drive section 50.

The drive signal transmission section 15 generates, from the raster data RAO, a drive signal SG1 corresponding to a voltage signal applied to the drive element 32 of the recording head 30 and outputs the drive signal SG1 to the drive circuit 31 of the recording head 30. For example, when the raster data RAO is “dot formation”, the drive signal transmission section 15 outputs a drive signal SG1 for ejecting ink droplets for dot formation. When the raster data RAO is four-value data, the drive signal transmission section 15 outputs a drive signal SG1 for ejecting ink droplets for large dots if the raster data RAO is “large dot formation”, outputs a drive signal SG1 for ejecting ink droplets for medium dots if the raster data RAO is “medium dot formation”, and outputs a drive signal SG1 for ejecting ink droplets for small dots if the raster data RAO is “small dot formation”.

Each of the sections 11 to 15 may be configured by an ASIC, and may data of a process target read directly from the RAM 21 or may processed data written directly into the RAM 21. Here, ASIC is an abbreviation of application specific integrated circuit.

The drive section 50 controlled by the controller 10 includes a carriage drive section 51 and a roller drive section 55. The drive section 50 drives the carriage drive section 51 to reciprocally move the carriage 52 along the main scanning direction D1, and drives the roller drive section 55 to feed the recording medium ME0 in the feed direction D3 along the transport path 59. As shown in FIG. 2, the main scanning direction D1 is a direction intersecting the alignment direction D4 of the nozzles 34, and is, for example, a direction orthogonal to the alignment direction D4. The feed direction D3 is a direction intersecting the main scanning direction D1, and is, for example, a direction orthogonal to the main scanning direction D1. In FIG. 1, the feed direction D3 is the right direction, the left side is referred to as the upstream side, and the right side is referred to as the downstream side. A sub-scanning direction D2 indicated in FIG. 3 is a direction opposite to the feed direction D3. As shown in FIG. 3, under the control of the controller 10, the carriage drive section 51 moves the carriage 52 in a forward direction D11 along the main scanning direction D1 in the forward path P1 of the main scanning P0, and moves the carriage 52 in a return direction D12, which is opposite to the forward direction D11, in the return path P2 of the main scanning P0. Note that the main scanning direction D1 is a generic term for the forward direction D11 and the return direction D12. It can be said that the carriage drive section 51 performs the main scanning P0 in which the relative position between the recording head 30 and the recording medium ME0 is changed in the forward path P1 and in the return path P2 along the main scanning direction D1, which intersects with the alignment direction D4 of the black nozzles 34K. The roller drive section 55 includes a transport roller pair 56 and a sheet paper discharge roller pair 57. Under the control of the controller 10, the roller drive section 55 performs sub-scanning in which the recording medium ME0 is fed in the feed direction D3 by rotating a driving transport roller of the transport roller pair 56 and a driving paper discharge roller of the paper discharge roller pair 57. It can be said that the roller drive section 55 performs sub-scanning in which the relative position between the recording head and the recording medium ME0 is changed along the sub-scanning direction D2, which intersects the main scanning direction D1. The recording medium ME0 is a material that holds a print image, and is formed of paper, resin, metal, or the like. The material of the recording medium ME0 is not particularly limited, and various materials such as resin, metal, and paper can be considered. The shape of the recording medium ME0 is also not particularly limited, and various shapes such as a rectangular shape and a roll shape may be considered, and a three dimensional shape may be used.

A recording head 30 is mounted on the carriage 52. The carriage 52 may be equipped with an ink cartridge 35 in which ink 36 to be ejected as ink droplets 37 is supplied to the recording head 30. Of course, the ink 36 may be supplied to the recording head 30 via a tube from an ink cartridge 35 installed outside the carriage 52. The carriage 52 provided with the recording head 30 is fixed to an endless belt (not shown), and is movable in the forward direction D11 and in the return direction D12 along a guide 53. The guide 53 is an elongated member whose longitudinal direction is oriented in the main scanning direction D1. The carriage drive section 51 is constituted by a servo motor, and moves the carriage 52 in the forward direction D11 and in the return direction D12 in accordance with commands from the controller 10.

During sub-scanning, the transport roller pair 56 located on the upstream side from the recording head 30 feeds the nipped recording medium ME0 toward the recording head 30 by rotation of the driving transport roller. During sub-scanning, the paper discharge roller pair 57 on the downstream side from the recording head 30 transports the nipped recording medium ME0 toward a paper discharge tray (not shown) by rotation of the driving paper discharge roller. The roller drive section 55 is constituted by a servo motor, operates the transport roller pair 56 and the paper discharge roller pair 57 in accordance with commands from the controller 10, and feeds the recording medium ME0 in the feed direction D3.

The platen 58 is at the lower side of the transport path 59 and supports the recording medium ME0 by contacting the recording medium ME0 on the transport path 59. The recording head controlled by the controller 10 causes the ink 36 to adhere to the recording medium ME0 by ejecting ink droplets 37 toward the recording medium ME0 supported by the platen 58.

The recording head 30 has, on a nozzle surface 30a, a plurality of nozzles 34 for ejecting ink droplets 37, and performs printing by discharging the ink droplets 37 to a recording medium ME0 on the platen 58. Here, nozzle means a small hole from which ink droplets are ejected, and nozzle row means an arrangement of a plurality of nozzles. The nozzle surface 30a is a ejection surface of ink droplets 37. The recording head 30 includes a drive circuit 31, a drive element 32, and the like. The drive circuit 31 applies a voltage signal to the drive element 32 in accordance with the drive signal SG1 input from the drive signal transmission section 15. As the drive element 32, piezoelectric elements that apply pressure to the ink 36 in pressure chambers that communicate with the nozzles 34, drive elements that generate air bubbles in the pressure chambers by heat and ejects ink droplets 37 from the nozzles 34, or the like can be used. The ink 36 is supplied from the ink cartridge 35 to the pressure chamber of the recording head 30. The ink 36 in the pressurizing chamber is ejected as ink droplets 37 from the nozzles 34 toward the recording medium ME0 by the drive element 32. Thus, dots 38 of the ink droplets 37 are formed on the recording medium ME0. The print image IM0 is formed on the recording medium ME0 by forming dots 38 according to the raster data RAO while the recording head 30 moves in the main scanning direction D1, and repeatedly feeding the recording medium ME0 in the feed direction D3 in increments of one sub-scanning.

The RAM 21 is a large-capacity volatile semiconductor memory, and stores the original image data DA1 received from the host device HO1, a memory (not shown), or the like. The communication I/F 22 is connected to the host device HO1 in a wired or wireless manner, and inputs and outputs information to and from the host device HO1. Examples of the host device HO1 include computers such as personal computers and tablet terminals, mobile phones such as smartphones, digital cameras, and digital video cameras. As the storage section 23, a nonvolatile semiconductor memory such as a flash memory, a magnetic storage device such as a hard disk, or the like can be used. The operation panel 24 includes an output section 25, an input section 26, and the like. The output section 25 includes, for example, a display section such as a liquid crystal panel that displays information according to various instructions and information indicating the state of the printer 2. The output section 25 may vocally output the information. The input section 26 is configured by an operation input section such as operation keys including a cursor key and a determination key. The input section 26 may be a touch panel or the like that receives an operation on a display screen.

The recording head 30 shown in FIG. 2 has, on the nozzle surface 30a, a plurality of nozzle rows 33 including a plurality of nozzles 34 arranged at intervals of a predetermined nozzle pitch in the alignment direction D4. Each nozzle row 33 ejects ink droplets 37 toward the recording medium ME0. Although the alignment direction D4 shown in FIGS. 2 and 3 is orthogonal to the main scanning direction D1, the alignment direction D4 may not be orthogonal to the main scanning direction D1 but may obliquely intersect the main scanning direction LA. In other words, the alignment direction D4 may coincide with the feed direction D3 as shown in FIG. 3, or may deviate from the feed direction D3 by less than 90°. The plurality of nozzles 34 included in each nozzle row 33 may be arranged in one row, or may be arranged in a staggered manner, that is, in two rows. Note that the alignment direction of the plurality of nozzles 34 arranged in a staggered manner is, focusing separately on each of the two rows, the alignment direction of the nozzles.

The recording head 30 shown in FIG. 2 is a vertical array head and has two nozzle rows 33 composed of a black nozzle row 33K and a color nozzle row 33A. In the black nozzle row 33K, a plurality of black nozzles 34K are aligned in the alignment direction D4. Each black nozzle 34K ejects black ink droplets 37K, which are K ink droplets 37. When a black ink droplet 37K lands on the recording medium ME0, a black dot 38K, which is a K dot 38, is formed on the recording medium ME0. The color nozzle row 33A is divided into a plurality of color nozzle groups 33G in the alignment direction D4. In each color nozzle group 33G, a plurality of color nozzles 34A are aligned along the black nozzle row 33K. Each color nozzle 34A ejects color ink droplets 37A, which are color ink droplets 37. In the color nozzle row 33A shown in FIG. 2, a yellow nozzle group 33Y, a magenta nozzle group 33M, and a cyan nozzle group 33C are aligned in this order in the sub-scanning direction D2. Therefore, the color nozzle groups 33G are aligned in order in the alignment direction D4 of the plurality of black nozzles 34K.

In the yellow nozzle group 33Y, a plurality of yellow nozzles 34Y for ejecting yellow ink droplets 37Y, which are Y ink droplets 37, are aligned along the black nozzle row 33K. When a yellow ink droplet 37Y lands on the recording medium ME0, a yellow dot 38Y which is a Y dot 38, is formed on the recording medium ME0. In the magenta nozzle group 33M, a plurality of magenta nozzles 34M for ejecting magenta ink droplets 37M, which are M ink droplets 37, are aligned along the black nozzle row 33K. When a magenta ink droplet 37M lands on the recording medium ME0, a magenta dot 38M, which is an M dot 38, is formed on the recording medium ME0. In the cyan nozzle group 33C, a plurality of cyan nozzles 34C for ejecting cyan ink droplets 37C, which are C ink droplets 37, are aligned along the black nozzle row 33K. When a cyan ink droplet 37C lands on the recording medium ME0, a cyan dot 38C, which is a C dot 38, is formed on the recording medium ME0.

Note that although in FIG. 2, the line of yellow nozzles 34Y and the line of magenta nozzles 34M are connected to each other, and the line of magenta nozzles 34M and the line of cyan nozzles 34C are connected to each other, the arrangement of the plurality of color nozzle groups 33G is not limited to the arrangement shown in FIG. 2. As long as the color nozzles 34A of each color nozzle group 33G are aligned along the black nozzle row 33K, the line of magenta nozzles 34M may be shifted away from the line of yellow nozzles 34Y, or the line of cyan nozzles 34C may be shifted away from the line of magenta nozzles 34M.

In the color nozzle row 33A shown in FIG. 2, assuming that the number of nozzles in each color nozzle group 33G is n, then yellow nozzles Yl to Yn, magenta nozzles Ml to Mn, and cyan nozzles Cl to Cn are aligned in the order of the sub-scanning direction D2. The number of nozzles in the black nozzle row 33K shown in FIG. 2 is 3n, and it is shown that the black nozzles Kl to K3n are aligned in the black nozzle row 33K in the order of the sub-scanning direction D2.

The recording head 30, which is a vertical array head, can be formed inexpensively because only two nozzle rows 33 are required, and high-speed monochrome printing can be realized by using a black nozzle row 33K that is three times as long as the color nozzle group 33G.

The printer 2 provided with the recording head 30 described above can perform color bidirectional band printing as shown in FIG. 3. Bidirectional printing means printing in which the ink droplets 37 are deposited on the recording medium ME0 in both the forward path P1 and the return path P2 in the main scanning P0 to form the dots 38. Forward path P1 means the main scanning P0 from the “Home” side toward the “Full” side in FIG. 3. Return path P2 means the main scanning P0 from the “Full” side to the “Home” side in FIG. 3. Color band printing of the vertical array head means printing in which color dots are formed by depositing color ink droplets 37A on the recording medium ME0 that are necessary for printing, wherein the color ink droplets 37A are deposited in one main scanning P0, which is between sub-scannings, from the color nozzle group 33G allocated to the band regions B0, each which corresponds to the length L0 in the sub-scanning direction D2 of the color nozzle groups. The controller 10 controls bidirectional printing in which color ink droplets 37A necessary for printing and from the color nozzle groups 33G allocated to each band region B0 are deposited in both the forward path P1 and the return path P2 in one main scanning P0, which is between sub-scannings.

As shown in FIG. 3, it is assumed that there are band regions B1, B2, B3, and B4 in the order of the sub-scanning direction D2 as the band regions B0, and that a print image IM0 is formed by a dot 38 of cyan ink droplets 37C and magenta ink droplets 37M. In the example shown in FIG. 3, all cyan ink droplets 37C necessary for printing are ejected to the band region B1 in the forward path P1 that is the m-th main scanning P0. This operation is labeled “C (m)” in FIG. 3. After a sub-scanning in the length L0, then in the return path P2 that is the (m+1) th main scanning P0, all the magenta ink droplets 37M necessary for printing are ejected to the band region B1 and all the cyan ink droplets 37C necessary for printing are ejected to the band region B2. These operations are labeled “M (m+1)” and “C (m+1)” in FIG. 3. After a sub-scanning in the length L0, then in the forward path P1 that is the (m+2) th main scanning P0, all the magenta ink droplets 37M necessary for printing are ejected to the band region B2 and all the cyan ink droplets 37C necessary for printing are ejected to the band region B3. These operations are labeled “M (m+2))” and “C (m+2))” in FIG. 3. After a sub-scanning in length L0, then in the return path P2 that is the (m+3) th main scanning P0, all magenta ink droplets 37M necessary for printing are ejected to the band region B3, and all cyan ink droplets 37C necessary for printing are ejected to the band region B4. These operations are labeled “M (m+3))” and “C (m+3))” in FIG. 3. After a sub-scanning in the length L0, then in the forward path P1 that is the (m+4) th main scanning P0, all the magenta ink droplets 37M necessary for printing are ejected to the band region B4. This operation is labeled “M (m+4))” in FIG. 3.

As described above, at the time of color bidirectional band printing, the printer 2 ejects the magenta ink droplets 37M in the return path P2 to the band region B0 in which the cyan ink droplets 37C are ejected in the forward path P1, and ejects the magenta ink droplets 37M in the forward path P1 to the band region B0 in which the cyan ink droplets 37C are ejected in the return path P2. For this reason, an ejection timing difference occurs between the cyan ink droplets 37C and the magenta ink droplets 37M according to the position in the band region B0 in the main scanning direction D1. Due to this timing difference, unevenness occurs in C and M coloring.

Similarly, at the time of color bidirectional band printing, the printer 2 ejects the yellow ink droplets 37C in the return path P2 to the band region B0 in which the magenta ink droplets 37Y are ejected in the forward path P1, and ejects the yellow ink droplets 37Y in the forward path P1 to the band region B0 in which the magenta ink droplets 37M are ejected in the return path P2. For this reason, an ejection timing difference occurs between the magenta ink droplets 37M and the yellow ink droplets 37Y according to the position in the band region B0 in the main scanning direction D1. Due to this timing difference, unevenness occurs in M and Y coloring.

When the colors C, M, and Y are mixed, the magenta ink droplets 37M are ejected to the band region B0 in the return path P2 where the cyan ink droplets 37C and the yellow ink droplets 37Y are ejected in the forward path P1. The magenta ink droplets 37M are ejected to the band region B0 in the forward path P1 where the cyan ink droplets 37C and the yellow ink droplets 37Y are ejected in the return path P2. Therefore, an ejection timing difference occurs between the magenta ink droplets 37M, and the cyan ink droplets 37C and the yellow ink droplets 37Y depending on the position in the band region B0 in the main scanning direction D1. This timing difference causes unevenness in between M coloring and C and Y coloring.

As described above, the plurality of color nozzle groups 33G include the first color nozzle group 331 and the second color nozzle group 332, which in bidirectional printing eject color ink droplets 37A to the band region B0 in mutually different colors in the forward path P1 and in the return path P2. In the example shown in FIG. 2, the cyan nozzle group 33C corresponds to the first color nozzle group 331, and the magenta nozzle group 33M corresponds to the second color nozzle group 332. Here, the color ink droplets 37A ejected by the first color nozzle group 331 are referred to as first color ink droplets 371, and the color ink droplets 37A ejected by the second color nozzle group 332 are referred to as second color ink droplets 372. In the example shown in FIG. 2, the cyan ink droplets 37C correspond to the first color ink droplets 371, and the magenta ink droplets 37M correspond to the second color ink droplets 372.

Of course, the first color nozzle group 331, the second color nozzle group 332, the first color ink droplets 371, and the second color ink droplets 372 are relatively determined. For example, the magenta nozzle group 33M may correspond to the first color nozzle group 331, the yellow nozzle group 33Y may correspond to the second color nozzle group 332, the magenta ink droplets 37M may correspond to the first color ink droplets 371, and the yellow ink droplets 37Y may correspond to the second color ink droplets 372.

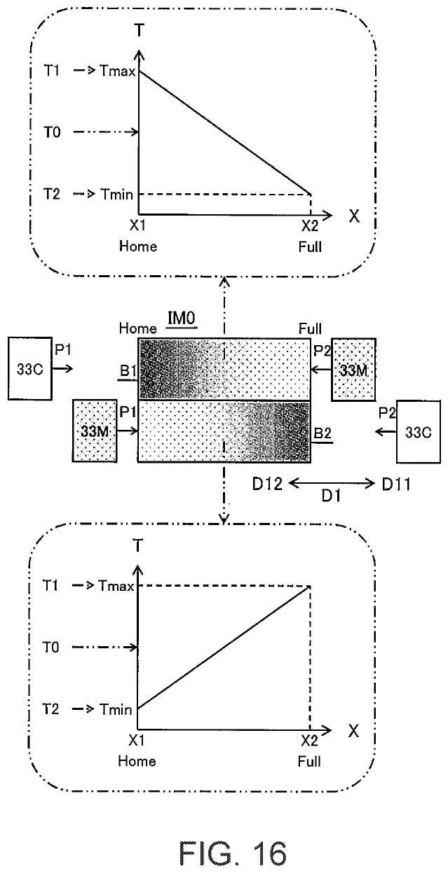

FIG. 16 schematically illustrates how color shift occurs in accordance with the ejection timing difference T occurring between the color ink droplets 37A of different colors. In the example shown in FIG. 16, cyan ink droplets 37C from the cyan nozzle group 33C land on the band region B1 in the forward path P1, and magenta ink droplets 37M from the magenta nozzle group 33M land on the band region B1 in the return path P2. The upper part of FIG. 16 shows timing difference T of the ejection of color ink droplets 37A with respect to positions X in the main scanning direction D1 within the band region B1. In the band region B2, the cyan ink droplets 37C from the cyan nozzle group 33C land in the return path P2, and the magenta ink droplets 37M from the magenta nozzle group 33M land in the forward path P1. The lower part of FIG. 16 shows timing difference T of the ejection of color ink droplets 37A with respect to positions X in the main scanning direction D1 within the band region B2.

In the case of the band region B1, as shown in the upper part of FIG. 16, the timing difference T between the ejection of the cyan ink droplets 37C and the ejection of the magenta ink droplets 37M becomes the maximum timing difference Tmax at the “Home” position, and becomes the minimum timing difference Tmin at the “Full” position. When correction of color unevenness is not performed, M coloring in the band region B1 gradually increases from the “Full” position toward the “Home” position. It is presumed that this is because at the “Home” position where the timing difference T is large, the color of the magenta ink that landed later appears more intense because the cyan ink that landed earlier had permeated into the recording medium ME0. From another point of view, it is presumed that at the “Full” position where the timing difference T is small, a large amount of the cyan ink that landed first still remains on the surface of the recording medium ME0, so that, even if the magenta ink lands later, a large amount of the color of the cyan ink still remains.

In the case of the band region B2, as shown in the lower part of FIG. 16, the timing difference T between ejection of the cyan ink droplets 37C and ejection of the magenta ink droplets 37M becomes the minimum timing difference Tmin at the “Home” position and becomes the maximum timing difference Tmax at the “Full” position. When correction of the color unevenness is not performed, M coloring in the band region B1 gradually increases from the “Home” position toward the “Full” position. It is presumed that this is because at the “Full” position where the timing difference T is large, the color of the magenta ink that landed later appears more intense because the cyan ink that landed earlier had permeated into the recording medium ME0. From another point of view, it is presumed that at the “Home” position where the timing difference T is small, a large amount of the cyan ink that had landed first remains on the surface of the recording medium ME0, so that even if the magenta ink lands later, a large amount of the color of the cyan ink still remains.

In this specific example, in order to compensate for the color shift that occurs in bidirectional printing due to the nozzle arrangement of a vertical array head, the adjustment pattern CH0 shown in FIG. 4 is formed on the recording medium ME0, and the color shift is compensated for by selection of a color shift compensation patch. The control section U1 includes the compensation section U2, which compensates for color shift that is caused by the timing difference T between ejection of first color ink droplets 371 and ejection of second color ink droplets 372 and that occurs depending on the position X in the band region B0 in the main scanning direction D1. In order to describe the adjustment pattern CH0, FIG. 16 shows a reference timing difference T0, which is a reference of the timing difference T, a first timing difference T1, which is larger than the reference timing difference T0, a position X1, which is at the first timing difference T1, a second timing difference T2, which is smaller than the reference timing difference T0, and a position X2, which is at the second timing difference T2.

FIG. 4 schematically illustrates the adjustment pattern CH0, which includes a plurality of the reference patches PA0, a plurality of the first patches PA1, and a plurality of the second patches PA2. The adjustment pattern CH0 is formed on the recording medium ME0. For convenience sake, the scanning directions of the cyan nozzle group 33C and the magenta nozzle group 33M are indicated by arrows in FIG. 4 for the case when the adjustment pattern CH0 is a mixture of C and M colors. FIG. 5 schematically illustrates forming conditions of each patch included in the mixed color adjustment patterns of C and M.

The controller 10 forms the reference patches PA0 on the recording medium ME0 by ejecting first color ink droplets 371 and second color ink droplets 372 in a predetermined recording density ratio at the reference timing difference T0. The reference timing difference T0 can be, for example, as shown in FIG. 16, the average (Tmax+Tmin)/2 of the maximum timing difference Tmax and the minimum timing difference Tmin. In this case, the reference timing difference T0 is also the timing difference T at an intermediate position between the “Home” position and the “Full” position in the main scanning direction D1. The predetermined recording density ratio between first color ink droplets 371 and second color ink droplets 372 can be, for example, an equivalence ratio. In the example shown in FIG. 5, cyan ink droplets 37C correspond to the first color ink droplets 371, magenta ink droplets 37M correspond to the second color ink droplets 372, the recording density of the cyan ink droplets 37C is 50%, and the recording density of the magenta ink droplets 37M is 50%. Here, the recording density (referred to as RD) means a ratio of the number of dots formed by ink droplets with respect to a predetermined number of pixels PX0, and means a ratio when converted to the largest dot (for example, large dot) in a case where dots having different sizes are formed. A pixel is the smallest element of an image to which a color can be independently assigned. For example, when an Nd number of large dots are formed in 100 pixels PX0, then the recording density RD is Nd %.

The controller 10 forms the plurality of first patches PA1 on the recording medium ME0 by ejecting the first color ink droplets 371 and the second color ink droplets 372 in a plurality of different recording density ratios at the first timing difference T1. Although the first timing difference T1 shown in FIG. 16 is the maximum timing difference Tmax, it is sufficient that the first timing difference T1 be a timing difference different from the reference timing difference T0 and the second timing difference T2, and is desirably a timing difference larger than the reference timing difference T0. The recording density ratio between the first color ink droplets 371 and the second color ink droplets 372 can be, for example, the recording density ratios shown in FIG. 5. The plurality of first patches PA1 shown in FIGS. 4 and 5 include first patches PA11 to PA16. The recording density of C in the first patches PA11 to PA16 is constant at 50%, which is the same as the recording density of C in the reference patch PA0. The recording densities of M of the first patches PA11, PA12, PA13, PA14, PA15, and PA16 are 50%, 45%, 40%, 35%, 30%, and 25%, respectively. When T1>T0, then usually the magenta ink droplets 37M ejected after the cyan ink droplets 37C have stronger coloring, and the first patch PA1 has stronger M coloring than does the reference patch PA0. Therefore, in each first patch PA1, the recording density of M is set to be equal to or lower than the recording density of C.

The controller 10 forms a plurality of second patches PA2 on the recording medium ME0 by ejecting first color ink droplets 371 and second color ink droplets 372 in a plurality of different recording density ratios at the second timing difference T2. Although the second timing difference T2 shown in FIG. 16 is the minimum timing difference Tmin, it is sufficient that the second timing difference T2 be a timing difference different from the reference timing difference T0 and the first timing difference T1, and is desirably a timing difference smaller than the reference timing difference T0. The recording density ratio between the first color ink droplets 371 and the second color ink droplets 372 can be, for example, the recording density ratios shown in FIG. 5. The plurality of second patches PA2 shown in FIGS. 4 and 5 include second patches PA21 to PA26. The recording density of C in the second patches PA21 to PA26 is constant at 50%, which is the same as the recording density of C in the reference patch PA0. The recording densities of M of the second patches PA21, PA22, PA23, PA24, PA25, and PA26 are 75%, 70%, 65%, 60%, 55%, and 50%, respectively. When T2<T0, the second patch PA2 usually has weaker M coloring than does the reference patch PA0. Therefore, in each second patch PA2, the recording density of M is set to be equal to or higher than the recording density of C.

The adjustment patterns CH0 shown in FIG. 4 include an adjustment pattern CH1 in which the first patches PA11 to PA16 and the plurality of reference patches PA0 are aligned in a row along the main scanning direction D1, and an adjustment pattern CH2 in which the second patches PA21 to PA26 and the plurality of reference patches PA0 are aligned in a row along the main scanning direction D1. The plurality of reference patches PA0 include the plurality of first reference patches PA01 included in the adjustment pattern CH1 and the plurality of second reference patches PA02 included in the adjustment pattern CH2. In the adjustment pattern CH1, the first patches PA11 to PA16 are arranged in order, and each first reference patch PA01 is arranged between first patches PA1. In the adjustment pattern CH2, the second patches PA21 to PA26 are arranged in order, and each second reference patch PA02 is arranged between second patches PA2. The controller 10 forms the patch arrangement in the adjustment pattern CH0 shown in FIG. 4 on the recording medium ME0.

In order to compensate for the color shift due to the timing difference T, a first color shift compensation patch PA1z is selected from the first patches PA11 to PA16, and a second color shift compensation patch PA2z is selected from the second patches PA21 to PA26. The first color shift compensation patch PA1z and the second color shift compensation patch PA2z may be selected by the user or by the printer 2. Since the first reference patches PA01 are arranged between the first patches PA1, it is possible to easily select the first color shift compensation patch PA1z from the plurality of first patches PA1. In addition, since the second reference patches PA02 are arranged between the second patches PA2, it is possible to easily select the second color shift compensation patch PA2z from the plurality of second patches PA2. FIG. 4 shows that the first patch PA13 is selected as the first color shift compensation patch PA1z and the second patch PA24 is selected as the second color shift compensation patch PA2z. As shown in FIG. 5, the first patch PA13 as the first color shift compensation patch PA1z has a ratio of recording density of magenta ink droplets 37M to recording density of cyan ink droplets 37C of 40/50. In this case, the recording density ratio R1 corresponding to the first color shift compensation patch PA1z is 40/50. The second patch PA24 serving as the second color shift compensation patch PA2z has a ratio of recording density of magenta ink droplets 37M to recording density of cyan ink droplets 37C of 60/50. In this case, the recording density ratio R2 corresponding to the second color shift compensation patch PA2z is 60/50.

The controller 10 performs control to align ejection of the first color ink droplets 371 and of the second color ink droplets 372 for forming the plurality of reference patches PA0, the plurality of first patches PA1, and the plurality of second patches PA2 in the forward path P1. The patches can be formed with a desired timing difference T by combination with reverse feeding of the recording medium ME0. As a matter of course, the controller may perform control for aligning ejection of the first color ink droplets 371 and the second color ink droplets 372 for forming the plurality of reference patches PA0, the plurality of first patches PA1, and the plurality of second patches PA2 in the return path P2.

The arrangement of the patches of the adjustment pattern CH0 is not limited to the example shown in FIG. 4. For example, the adjustment patterns CH1 and CH2 may be arranged in a line along the sub-scanning direction D2, or may be arranged diagonally so as to intersect the main scanning direction D1 and the sub-scanning direction D2.

FIG. 6 schematically illustrates forming conditions of each patch included in the mixed color adjustment patterns of M and Y. The forming conditions of each patch in this case are the same as the conditions for forming each patch shown in FIG. 5. The recording densities of the first color ink droplets 371 and the second color ink droplets 372 in the reference patch PA0 are both 50%. In the case of T1>T0, usually the coloring of yellow ink droplets 37Y ejected after magenta ink droplets 37M becomes stronger, and the coloring of Y in the first patches PA1 becomes stronger than the reference patch PA0. Therefore, in each first patches PA1, the recording density of Y is set to be equal to or lower than the recording density of M. When T2<T0, the second patches PA2 usually have a weaker Y color than the reference patch PA0. Therefore, in each second patches PA2, the recording density of Y is set to be equal to or higher than the recording density of M.

Although not illustrated, the forming conditions of each patch can also be set for the mixed color adjustment patterns of C, M, and Y, and the adjustment patterns can be formed in accordance with the forming conditions of each patch.

FIG. 7 schematically illustrates how the correction value corresponding to the timing difference T of ejection of color ink droplets 37A is calculated.

As described above, when the timing difference T is the first timing difference T1, the first color shift compensation patch PA1z is selected from the plurality of first patches PA1. Therefore, the recording density ratio R corresponding to the first timing difference T1, that is, the ratio of the recording density ratio of the second color ink droplets 372 to the recording density of the first color ink droplets 371, is the recording density ratio R1 corresponding to the first color shift compensation patch PA1z. When the timing difference T is the second timing difference T2, the second color shift compensation patch PA2z is selected from the plurality of second patches PA2. Therefore, the recording density ratio R corresponding to the second timing difference T2 becomes the recording density ratio R2 corresponding to the second color shift compensation patch PA2z.

Assuming that the timing difference T1 between the first timing difference T1 and the second timing difference T2 is at a position Xi between the positions X1 and X2 shown in FIG. 16, then the timing difference T1 can be calculated by linear interpolation.

$$\begin{matrix}Equation 1 & \\ \begin{matrix}In the case of the forward path \\ Ti = \frac{X 2 - Xi}{X 2 - X 1} ( T 1 - T 2 ) + T 2\end{matrix} & ( 1 )\end{matrix}$$

$$\begin{matrix}Equation 2 & \\ \begin{matrix}In the case of the return path \\ Ti = \frac{X i - X 1}{X 2 - X 1} ( T 1 - T 2 ) + T 2\end{matrix} & ( 2 )\end{matrix}$$

The recording density ratio Ri corresponding to the timing difference T1 can be calculated by linear interpolation.

$$\begin{matrix}Equation 3 & \\ Ri = \frac{T 1 - Ti}{T 1 - T 2} ( R 2 - R 1 ) + R 1 & ( 3 )\end{matrix}$$

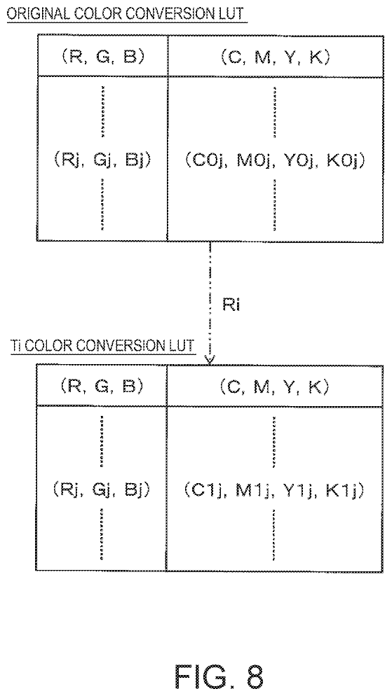

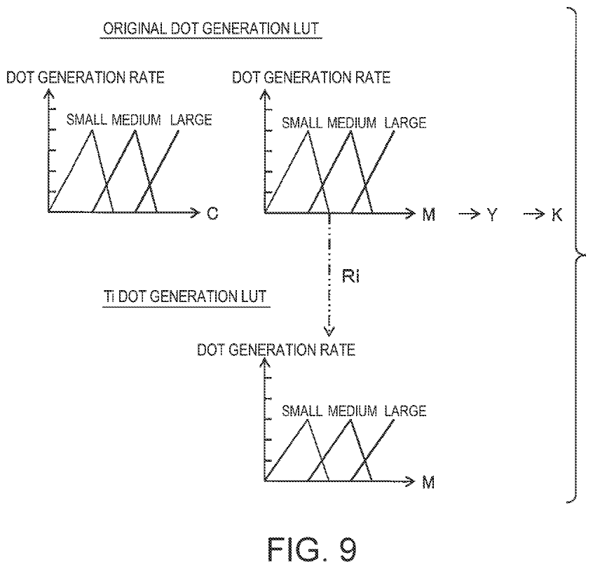

The recording density ratio Ri becomes a correction value for compensating the color shift due to the timing difference T, and is used to generate the correction data shown in FIGS. 8 and 9. The correction data may be a color conversion LUT as shown in FIG. 8 or a dot generation LUT as shown in FIG. 9.

FIG. 8 schematically shows an example of generating a color conversion LUT as correction data.

The original color conversion LUT shown in FIG. 8 is a color conversion LUT used in the color conversion section 12 of FIG. 1 when the color shift due to the timing difference T is not compensated. The original color conversion LUT is data representing a correspondence relationship between coordinate values (R, G, B) in the RGB color space on the input side and coordinate values (C, M, Y, K) in the CMYK color space on the output side. Assuming that a variable for identifying a grid point set in the RGB color space is j, the original color conversion LUT shown in FIG. 8 is data having output coordinate values (C0j, M0j, Y0j, K0j) associated with input coordinate values (Rj, Gj, Bj) for each grid point. The color conversion section 12 can convert the original image data DA1 into the ink amount data DA2 with reference to the original color conversion LUT.

Based on the recording density ratio Ri, the controller 10 or the host device HO1 generates different Ti color conversion LUTs, in gradations, according to the timing difference Ti. Based on the recording density ratio Ri for each grid point, the controller 10 or the host device HO1 obtains the output coordinate values (C1j, M1j, Y1j, K1j) from the output coordinate values (C0j, M0j, Y0j, K0j) of the original color conversion LUT, and generates a Ti color conversion LUT having the output coordinate values (C1j, M1j, Y1j, K1j) associated with the input coordinate values (Rj, Gj, Bj) for each grid point. In the case of compensating the color shift in the mixture of C and M color, when the recording density ratio of the magenta ink droplets 37M to the cyan ink droplets 37C is Ri, then as a simple example, C1j=C0j, M1j=Ri×M0j, Y1j=Y0j, and K1j=K0j may be satisfied. However, the output coordinate values (C1j, M1j, Y1j, K1j) are obtained taking into consideration that the output coordinate value M1j has a possible range and the total of the output coordinate values C1j, M1j, Y1j, K1j has an upper limit.

The color conversion LUT requires a large amount of data. Therefore, the controller 10 or the host device HO1 generates different Ti color conversion LUTs according to gradations of timing differences Ti, for example, a color conversion LUT for a timing difference of 100 milliseconds, a color conversion LUT for a timing difference of 200 milliseconds, and a color conversion LUT for a timing difference of 500 milliseconds.

FIG. 9 schematically shows an example of generating a dot generation LUT as correction data.

The original dot generation LUT shown in FIG. 9 is a dot generation LUT used in the halftone processing section 13 of FIG. 1 when the color shift due to the timing difference T is not compensated for. The original dot generation LUT is data representing the correspondence relationship between the ink amount and the generation rate of dots 38 for each of C, Y, M, and K. In the graphs of the original dot generation LUT and the Ti dot generation LUT shown in FIG. 9, the horizontal axis represents the ink amount and the vertical axis represents the generation rate of dots 38. When there are three types of dots, that is, a small dot, a medium dot, and a large dot, the original dot generation LUT is data indicating the generation rates of small dots, medium dots, and large dots. The halftone processing section 13 can generate four-value halftone data DA3 by converting the ink amount of the ink amount data DA2 into the generation rate of each of the small, medium, and large dots while referring to the original dot generation LUT.

Based on the recording density ratio Ri, the controller 10 or the host device HO1 generates gradations of different Ti dot generation LUTs according to timing differences Ti. Based on the recording density ratio Ri, the controller 10 or the host device HO1 determines generation rates of small, medium, and large dots corresponding to the ink amounts in the Ti dot generation LUT from the generation rates of the small, medium, and large dots corresponding to the ink amounts in the original dot generation LUT and generates a Ti dot generation LUT having the determined dot generation rates. In the case of the recording density ratio of the magenta ink droplets 37M to the cyan ink droplets 37C is Ri when compensating the color shift in the mixture of C and M colors, as a simple example, the generation rate of small, medium, and large dots according to the ink amount in the Ti dot generation LUT for M may be a dot generation rate obtained by multiplying the generation rate of small, medium, and large dots according to the ink amount in the original dot generation LUT for M by the recording density ratio Ri. However, the generation rates of small, medium, and large dots according to the amount of ink are obtained taking into consideration that the dot generation rate of the dot generation LUT of each color has a possible range in and the total amount of ink ejected to one pixel PX0 has an upper limit.

The controller 10 or the host device HO1 generates different Ti dot generation LUTs according to gradations of timing differences Ti, for example, a dot generation LUT for a timing difference of 100 milliseconds, a dot generation LUT for a timing difference of 200 milliseconds, . . . and a dot generation LUT for a timing difference of 500 milliseconds.

### (3) Specific Example of Processes Performed by the Printing Device

FIG. 10 schematically illustrates a correction data generation process. The correction data generation process is performed by the compensation section U2 shown in FIG. 1, and is performed by, for example, the controller 10 shown in FIG. 1. In this case, the correction data generation process is started upon the input section 26 receiving an operation for starting the correction data generation process from the user. A part of the correction data generation process may be performed by the host device HO1 shown in FIG. 1. In this case, the correction data generation process is started upon the host device HO1 receiving an operation for starting the correction data generation process from the user. The adjustment pattern forming process of steps S102 to S112 shown in FIG. 10 corresponds to the reference patch formation step ST1, the first patch formation step ST2, and the second patch formation step ST3. The processes in steps S114 to S118 corresponds to the print image formation step ST4. Hereinafter, the description of “step” may be omitted, and reference numerals of steps may be indicated in parentheses. Further, it is assumed that the controller 10 performs the correction data generation process.

When the correction data generation process is started, the controller 10 sets one patch to be printed, from the adjustment pattern CH0 shown in FIG. 4 (S102). The patch to be set is one of the reference patch PA0, a first patch PA1, or a second patch PA2. In the example shown in FIG. 4, from the adjustment pattern CH1, the first patch PA11, the first reference patch PA01, the first patch PA12, . . . , and the first patch PA16 are set in this order, and then, from the adjustment pattern CH2, the second patch PA21, the second reference patch PA02, second patch PA22, . . . , and the second patch PA26 are set in this order.

Next, the controller 10 performs control to cause the recording head 30 to eject the first color ink droplets 371 having the set recording density for forming the set patch in the forward path P1 (S104). The forming conditions of the patches are shown in FIGS. 5 and 6, for example. When forming a mixed color adjustment pattern for C and M, the controller 10 causes the recording head 30 to eject cyan ink droplets 37C at the set recording density from the cyan nozzle group 33C.

Next, the controller 10 returns the carriage 52 on which the recording head 30 is mounted to the print start position of the set patch in the main scanning direction D1, and performs control to perform sub-scanning by the length L0 (S106).

Next, the controller 10 measures the timing difference of ink droplet ejection allocated to the set patch with the start of ejection of the first color ink droplets 371 as a starting point (S108). The controller 10 measures the reference timing difference T0 when the patch is the reference patch PA0, measures the first timing difference T1 when the patch is the first patch PA1, and measures the second timing difference T2 when the patch is the second patch PA2.

Next, the controller 10 performs control to cause the recording head 30 to eject the second color ink droplets 372 having the set recording density for forming the set patch in the forward path P1 (S110). As described above, the forming conditions of each patch are shown in FIGS. 5 and 6, for example. When forming a mixed color adjustment pattern for C and M, the controller 10 causes the recording head 30 to eject magenta ink droplets 37M at the set recording density from the magenta nozzle group 33M.

Next, the controller 10 determines whether or not all the patches included in the adjustment pattern CH0 have been printed (S112), returns the process to S102 when there are remaining patches to be printed, and advances the process to S114 when all the patches have been printed. When the patch to be set next is at a position toward the forward direction D11 as indicated in between the adjustment patterns CH1 and CH2 shown in FIG. 4, then in S102 the controller 10 performs control to reverse feed the recording medium ME0 by the distance of one sub-scanning in order to match the print start position of the set patch. The adjustment pattern forming process of S102 to S112 is performed for each of, for example, a mixed color adjustment pattern of C and M, a mixed color adjustment pattern of M and Y, and a mixed color adjustment pattern of C, M, and Y.

In accordance with the adjustment pattern forming process described above, the controller 10 forms the reference patch PA0 on the recording medium ME0 by ejecting first color ink droplets 371 and second color ink droplets 372 in a predetermined recording density ratio at the reference timing difference T0. At this time, the controller 10 aligns ejections of the first color ink droplets 371 and of the second color ink droplets 372 for forming the reference patch PA0 on the recording medium ME0 in the forward path P1. Further, the controller 10 forms a plurality of first patches PA1 on the recording medium ME0 by ejecting first color ink droplets 371 and second color ink droplets 372 in a plurality of different recording density ratios at the first timing difference T1. At this time, the controller 10 aligns ejection of the first color ink droplets 371 and the second color ink droplets 372 for forming the first patches PA1 on the recording medium ME0 in the forward path P1. Further, the controller 10 forms a plurality of second patches PA2 on the recording medium ME0 by ejecting first color ink droplets 371 and second color ink droplets 372 in a plurality of different recording density ratios at the second timing difference T2. At this time, the controller aligns ejection of the first color ink droplets 371 and the second color ink droplets 372 for forming the second patches PA2 on the recording medium ME0 in the forward path P1.

After the formation of the adjustment pattern CH0, the controller 10 selects a first color shift compensation patch PA1z from the plurality of first patches PA1, and selects a second color shift compensation patch PA2z from the plurality of second patches PA2 (S114). Two or more first color shift compensation patches PA1z may be selected from the plurality of first patches PA1, and two or more second color shift compensation patches PA2z may be selected from the plurality of second patches PA2.

In order to select the first color shift compensation patch PA1z and the second color shift compensation patch PA2z, the controller 10 may perform control to print different identification information corresponding to each of the first patches PA11 to PA16 and the second patches PA21 to PA26. In this case, the controller 10 may perform a process of receiving a selection operation of identification information indicating the first color shift compensation patch PA1z that was selected from the first patches PA11 to PA16 and receiving a selection operation of identification information indicating the second color shift compensation patch PA2z that was selected from the second patches PA21 to PA26.

In a case where the printer 2 includes the reading section 60, the controller 10 may cause the reading section 60 to read the recording medium ME0 having the adjustment pattern CH0, acquire the reading results SC0 of each patch, and acquire the first color shift compensation patch PA1z and the second color shift compensation patch PA2z based on the reading results SC0. The reading results SC0 include reading results of the plurality of first reference patches PA01, the first patches PA11 to PA16, the plurality of second reference patches PA02, and the second patches PA21 to PA26. The controller 10 can select, as the first color shift compensation patch PA1z, the patch among the first patches PA11 to PA16 that has the reading result closest to the average of the reading results of the first reference patches PA01. In addition, the controller 10 can select, as the second color shift compensation patch PA2z, the patch among the second patches PA21 to PA26 that has the reading result closest to the average of the reading results of the second reference patches PA02.

In a case where the printer 2 includes a colorimeter, the controller 10 may cause the colorimeter to read the adjustment pattern CH0, acquire the reading results SC0 of each patch, and acquire the first color shift compensation patch PA1z and the second color shift compensation patch PA2z based on the reading results SC0.

After selecting the first color shift compensation patch PA1z and the second color shift compensation patch PA2z, then the controller 10 determines a recording density ratio Ri, as a correction value, based on the recording density ratio R1 corresponding to the first color shift compensation patch PA1z and the recording density ratio R2 corresponding to the second color shift compensation patch R2 (S116). When a plurality of first color shift compensation patches PA1z are selected, the average of the recording density ratios corresponding to the first color shift compensation patches PA1z may be treated as the recording density ratio R1. When a plurality of second color shift compensation patches PA2z are selected, the average of the recording density ratios corresponding to the second color shift compensation patches PA2z may be treated as the recording density ratio R2.

As described with reference to FIGS. 7 and 16, the timing difference T1 corresponding to the position Xi in the band region B0 in the main scanning direction D1 can be calculated using the position X1 corresponding to the first timing difference T1 and the position X2 corresponding to the second timing difference T2 in accordance with Equations 1 and 2 described above. When the timing difference T1 is obtained, the recording density ratio Ri, as a correction value, can be calculated using the recording density ratio R1 corresponding to the first color shift compensation patch PA1z and the recording density ratio R2 corresponding to the second color shift compensation patch PA2z in accordance with Equation 3 described above.

After determining the recording density ratio Ri, then based on the recording-density ratio Ri, the controller 10 generates the correction data for compensating for the color shift due to the timing difference Ti (S118), and ends the correction data generation process. The correction data includes the color conversion LUT described with reference to FIG. 8, the dot generation LUT described with reference to FIG. 9, and the like. When the correction data is a color conversion LUT, the controller generates, in gradations, different Ti color conversion LUTs according to the timing difference Ti based on the recording density ratio Ri. When the correction data is the dot generation LUT, then based on the recording density ratio Ri, the controller generates, in gradations, different Ti dot generation LUTs according to the timing differences Ti.

FIG. 11 schematically illustrates a print control process for compensating for the color shift due to the timing difference T depending on need. The print control process is performed by the compensation section U2 shown in FIG. 1, for example, by the controller 10 shown in FIG. 1. In this case, when the color conversion section 12 acquires the original image data DA1, the print control process starts. A part of the print control process may be performed by the host device HO1 shown in FIG. 1. In this case, when the host device HO1 receives an operation to print the original image data DA1 from the user, the print control process starts. The print control process shown in FIG. 11 corresponds to the print image formation step ST4. In the following description, it is assumed that the controller 10 performs the print control process.

When the print control process starts, the controller acquires the original image data DA1 (S202). The original image data obtaining process of S202 includes a process such as storing the original image data DA1 received from the host device HO1 in the RAM 21 and a process such as storing the original image data DA1 from a memory (not shown) into the RAM 21.

Next, the controller 10 causes the color conversion section 12 to convert the original image data DA1 into the ink amount data DA2 with reference to a color conversion LUT for a normal mode, for example, the original color conversion LUT shown in FIG. 8 (S204).

Next, the controller 10 causes the halftone processing section 13 to convert the ink amount of the ink amount data DA2 into a dot generation rate while referring to a dot generation LUT for the normal mode, for example, the original dot generation LUT shown in FIG. 9, and generates halftone data DA3 (S206).

Next, the controller 10 causes the rasterization processing section 14 to generate raster data RAO by performing a rasterization process that rearranges the halftone data DA3 into the order in which the dots 38 are formed by the drive section 50 (S208).

Next, the controller 10 determines whether or not to compensate for the color shift due to the timing difference T (S210). For example, the controller 10 compensates for the color shift due to the timing difference T in S212 to S214 when the set print mode is a mode in which color bidirectional band printing is performed, and does not perform the process of compensating for the color shift due to the timing difference T when the set print mode is another mode. The other modes include a mode for performing monochrome printing, a mode for performing unidirectional printing, a mode for performing interlace printing, and the like.

In a case where the process of compensating for the color shift due to the timing difference T is not performed, the controller 10 causes the process to proceed to S216, and causes the drive signal transmission section 15 to generate the drive signal SG1 from the raster data RAO and output the drive signal SG1 to the drive circuit 31 of the recording head 30. Thus, the print image IM0 is formed on the recording medium ME0.

When compensation for the color shift due to the timing difference T is performed, the controller 10 acquires a timing difference Ti of ink droplet ejection corresponding to a position Xi in the main scanning direction D1 for each band region B0 of the print image IM0 (S212). For example, when the correction data is a color conversion LUT, a process of compensating for the color shift is performed with the ink amount data DA2 obtained in S204 as a target. In this case, by the rasterization process S208, the controller 10 can grasp which position Xi of which band region B0 that each section of the ink amount data DA2 corresponds to. When the correction data is a dot generation LUT, a process of compensating for the color shift is performed on the halftone data DA3 obtained in S206. In this case, by the rasterization process of S208, the controller 10 can grasp which position Xi of which band region B0 that each section of the halftone data DA3 corresponds to.

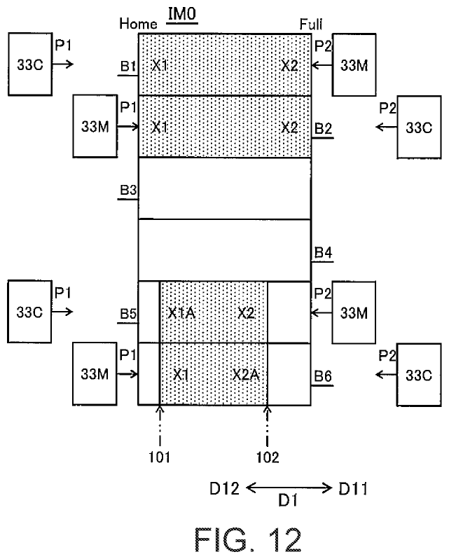

The timing difference Ti corresponding to the position Xi can basically be calculated according to Equations 1 and 2 described above. Here, in a case where the recording head 30 always moves from the “Home” position to the “Full” position in the forward path P1 and moves from the “Full” position to the “Home” position in the return path P2, the “Home” position may be set as the position X1 and the “Full” position may be set as the position X2. However, as shown in FIG. 12, when the recording head does not move to a portion of the print image IM0 where color ink droplets 37A are not ejected, it is necessary to shift the position X1 from the “Home” position or shift the position X2 from the “Full” position.

FIG. 12 schematically shows an example in which a print image IM0 of a mixture of the C and M colors is formed by color bidirectional band printing.

With respect to the band region B1 in the example shown in FIG. 12, the cyan nozzle group 33C moving in the forward path P1 from the “Home” position to the “Full” position ejects cyan ink droplets 37C in the band region B1, and the magenta nozzle group 33M moving in the return path P2 from the “Full” position to the “Home” position ejects magenta ink droplets 37M in the band region B1. In this case, the timing difference Ti corresponding to the position Xi can be calculated according to Equation 1 for the forward path P1, with the “Home” position as the position X1 and the “Full” position as the position X2.

With respect to the band region B2, the cyan nozzle group 33C moving in the return path P2 from the “Full” position to the “Home” position ejects cyan ink droplets 37C in the band region B2, and the magenta nozzle group 33M moving in the forward path P1 from the “Home” position to the “Full” position ejects magenta ink droplets 37M in the band region B2. In this case, the timing difference Ti corresponding to the position Xi can be calculated according to Equation 2 for the return path P2, with the “Home” position as the position X1 and the “Full” position as the position X2.

The ink droplets 37 are not ejected to the band regions B3 and B4. Therefore, the carriage 52 on which the recording head 30 is mounted does not move in the band regions B3 and B4.

With respect to the band region B5, the cyan nozzle group 33C moving in the forward path P1 from an intermediate position 101, which is closer to “Full” than to the “Home” position, to an intermediate position 102, which is closer to “Home” than the to “Full” position, ejects cyan ink droplets 37C in the band region B5. The magenta nozzle group 33M moving in the return path P2 from the intermediate position 102 to the intermediate position 101 ejects magenta ink droplets 37M in the band region B5. In this case, the timing difference Ti may be calculated with the intermediate position 102 as the position X2. Assuming that the intermediate position 101 is a position X1A, the position X1A corresponds to a position in the band area B1 that is closer to “Full” from the halfway position 102 by a difference between the “Full” position and the halfway position 101. Here, the timing difference Ti corresponding to the position Xi can be calculated in accordance with Equation 1 for the forward path P1, wherein the intermediate position 101 is assumed to be the position X1A and the intermediate position 102 is assumed to be the position X2.

With respect to the band region B6, the cyan nozzle group 33C moving in the return path P2 from the intermediate position 102 to the intermediate position 101 ejects cyan ink droplets 37C in the band region B6, and the magenta nozzle group 33M moving in the forward path P1 from the intermediate position 101 to the intermediate position 102 ejects magenta ink droplets 37M in the band region B6. In this case, the timing difference Ti may be calculated with the intermediate position 101 as the position X1. Assuming that the intermediate position 102 is a position X2A, the position X2A corresponds to a position in the band area B2 that is closer to “Home” from the intermediate position 101 by a difference between the intermediate position 102 and the “Home” position. Therefore, the timing difference Ti corresponding to the position Xi can be calculated in accordance with Equation 2 for the return path P2, with the intermediate position 101 as the position X1 and the intermediate position 102 as the position X2A.

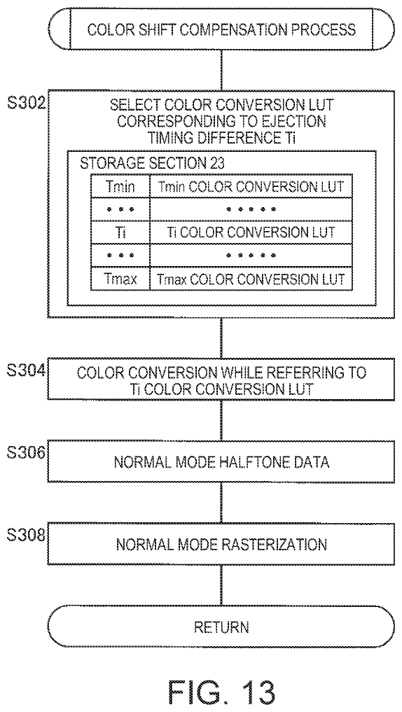

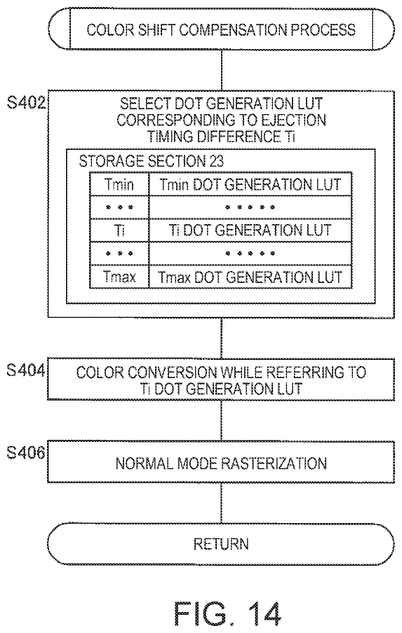

After obtaining the timing difference Ti, the controller performs a color shift compensation process (S214). For example, when the correction data is a color conversion LUT, the controller can compensate for the color shift due to the timing difference Ti in accordance with the process shown in FIG. 13. When the correction data is a dot generation LUT, the controller 10 can compensate for the color shift due to the timing difference T1 in accordance with the process shown in FIG. 14.

FIG. 13 schematically illustrates a color shift compensation process using a color conversion LUT. It is assumed that the storage section 23 shown in FIG. 1 stores different Ti color conversion LUTs according to gradations of timing differences Ti from a Tmin color conversion LUT to a Tmax color conversion LUT.

When the color shift compensation process shown in FIG. 13 is started, the controller 10 selects the Ti color conversion LUT corresponding to the ink droplet ejection timing difference Ti (S302). Next, the controller 10 causes the color conversion section 12 to convert the original image data DA1 into the ink amount data DA2 while referring to the selected Ti color conversion LUT (S304). The ink amount of the obtained ink amount data DA2 is corrected so that the color shift due to the timing difference T of ink droplet ejection is compensated for. Next, the controller 10 causes the halftone processing section 13 to convert the ink amount of the ink amount data DA2 into a dot generation rate while referring to a dot generation LUT for the normal mode, for example, while referring to the original dot generation LUT shown in FIG. 9, and then generates halftone data DA3 (S306). Finally, the controller 10 causes the rasterization processing section 14 to perform a rasterization process to generate raster data RAO from the halftone data DA3 (S308).

As described above, the Ti color conversion LUTs are provided with respect to the timing difference Ti only in gradations. Therefore, the controller 10 may compensate for the color shift due to the timing difference (referred to as Td) that is between the timing difference Ti and a timing difference Ti+1 by using a Ti color conversion LUT that corresponds to the timing difference Ti and a Ti+1 color conversion LUT that corresponds to the timing difference Ti+1. For example, the controller 10 may convert the original image data DA1 into a first ink amount while referring to the Ti color conversion LUT, convert the original image data DA1 into a second ink amount while referring to the Ti+1 color conversion LUT, and perform linear interpolation between the first ink amount and the second ink amount to generate ink amount data DA2 in which the color shift due to the timing difference Td is compensated for.

FIG. 14 schematically illustrates a color shift compensation process using a dot generation LUT. It is assumed that the storage section 23 shown in FIG. 1 stores different Ti dot generation LUTs according to gradations of timing differences Ti from the Tmin dot generation LUT to the Tmax dot generation LUT.

When the color shift compensation process shown in FIG. 14 is started, the controller 10 selects the Ti dot generation LUT corresponding to the timing difference Ti of ink droplet ejection (S402). Next, the controller 10 causes the halftone processing section 13 to convert the ink amount of the ink amount data DA2 into a dot generation rate while referring to the selected Ti dot generation LUT, and then generates a halftone data DA3 (S404). The obtained halftone data DA3 is corrected so that the color shift due to the timing difference T of ink droplet ejection is compensated for. Finally, the controller 10 causes the rasterization processing section 14 to perform a rasterization process to generate raster data RAO from the halftone data DA3 (S406).

As described above, the Ti dot generation LUT is provided with respect to the timing difference Ti only in gradations. Here, the controller 10 may compensate for the color shift due to the timing difference (referred to as Td) that is between the timing difference Ti and a timing difference Ti+1 using the Ti dot generation LUT, which corresponds to the timing difference Ti, and a Ti+1 dot generation LUT, which corresponds to the timing difference Ti+1. For example, the controller 10 may convert the ink amount data DA2 into a first dot generation rate while referring to the Ti dot generation LUT, convert the ink amount data DA2 into a second dot generation rate while referring to the Ti+1 dot generation LUT, and perform linear interpolation between the first dot generation rate and the second dot generation rate to generate the halftone data DA3 in which the color shift due to the timing difference Td is compensated for.

As described above, in accordance with the processes of S114 to S118 and S202 to S214 shown in FIGS. 10 and 11, the controller 10 compensates for the color shift due to the timing difference T, based on the recording density ratio R1 corresponding to the first color shift compensation patch PA1z and the recording density ratio R2 corresponding to the second color shift compensation patch PA2z.

After the color shift compensation process, the controller 10 causes the drive signal transmission section 15 to generate the drive signal SG1 from the raster data RAO and output the drive signal SG1 to the drive circuit 31 of the recording head 30 (S216), and ends the print control process. Thus, the print image IM0 is formed on the recording medium ME0.

As described above, the controller 10 forms the print image IM0 by compensating for the color shift due to the timing difference T based on the recording density ratios R1 and R2.

The reference patch PA0 shown in FIG. 4 indicates a print color when the timing difference T between the ejection of the first color ink droplets 371 and the ejection of the second color ink droplets 372 is equal to the reference timing difference T0. The first patches PA1 shown in FIG. 4 indicate correction color candidates for the case when the timing difference T of ink droplet ejection is larger than the reference timing difference T0. The second patches PA2 shown in FIG. 4 indicate correction color candidates for the case when the timing difference T of ink droplet ejection is smaller than the reference timing difference T0. The color shift due to the timing difference T of ink droplet ejection is compensated for based on the recording density ratio R1 corresponding to the first color shift compensation patch PA1z that was selected from the plurality of first patches PA1, and the recording density ratio R2 corresponding to the second color shift compensation patch PA2z that was selected from the plurality of second patches PA2. Therefore, this specific example can reduce color unevenness caused by the vertical array head.

### (4) Modifications

Various modifications can be made to the present disclosure.

For example, the combination of ink colors is not limited to C, M, Y, and K, and may include orange, green, white, colorless, and the like. Of course, even in a case where the printing device 1 does not use any one of C, M, and Y inks, the present technology can be applied even in a case where two or more kinds of color inks other than black are used.

When the host device HO1 converts the original image data DA1 into the ink amount data DA2, the printer 2 may receive the ink amount HO1 from the host device DA2 and form the print image IM0. Further, when the host device HO1 generates the halftone data DA3 from the ink amount data DA2, the printer 2 may receive the halftone data DA3 from the host device HO1 and form the print image IM0. Further, when the host device HO1 generates the raster data RAO from the halftone data DA3, the printer 2 may receive the raster data RAO from the host device HO1 and form the print image IM0.

That which performs the above-described processes is not limited to the CPU, and may be an electronic component other than the CPU, such as an ASIC. Of course, a plurality of CPUs may perform the above-described processes in cooperation with each other, or a CPU and another electronic component (for example, an ASIC) may perform the above-described processes in cooperation with each other.

The above-described processes can be appropriately changed.

In the above-described adjustment pattern CH1, each first reference patch PA01 is arranged between first patches PA1, and in the above-described adjustment pattern CH2, each second reference patch PA02 is arranged between second patches PA2, but the present disclosure is not limited thereto. For example, the first patches PA1 may be adjacent to each other, the first reference patch PA01 may be separated from the plurality of first patches PA1, the second patches PA2 may be adjacent to each other, or the second reference patch PA02 may be separated from the plurality of second patches PA2. Further, the reference patches PA0 may not be divided into the first reference patches PA01 and the second reference patches PA02, and the reference patches PA0 may be arranged between the first patches PA1 and the second patches PA2.

The printing device 1 may print an adjustment pattern that does not include the second patches PA2. In this case, the controller 10 or the host device HO1 can compensate the color shift due to the timing difference T of ink droplet ejection based on the recording density ratio R1 corresponding to the first color shift compensation patch PA1z that was selected from the plurality of first patches PA1. In this case, it is sufficient that the first timing difference T1 be a timing difference different from the reference timing difference T0, and may be smaller than the reference timing difference T0. Here, an intermediate position between the “Home” position and the “Full” position is set to X0. Position X0 is the position of reference timing difference T0. The timing difference T1 corresponding to the position Xi can be calculated by linear interpolation.

$$\begin{matrix}Equation 4 & \\ \begin{matrix}In the case of the forward path \\ Ti = \frac{X 0 - Xi}{X 0 - X 1} ( T 1 - T 0 ) + T 0\end{matrix} & ( 4 )\end{matrix}$$

$$\begin{matrix}Equation 5 & \\ \begin{matrix}In the case of the return path \\ Ti = \frac{X i - X 1}{X 0 - X 1} ( T 1 - T 0 ) + T 0\end{matrix} & ( 5 )\end{matrix}$$

The recording density ratio Ri corresponding to the timing difference T1 can be calculated by linear interpolation.

$$\begin{matrix}Equation 6 & \\ Ri = \frac{T 1 - Ti}{T 1 - T 0} ( R 0 - R 1 ) + R 1 & ( 6 )\end{matrix}$$

By the above, the color shift due to the timing difference T of ink droplet ejection is compensated based on the recording density ratio R1 corresponding to the first color shift compensation patch PA1z that was selected from the plurality of first patches PA1. Therefore, it is possible to reduce the color unevenness caused by the vertical array head, even when there are no second patches PA2 in the adjustment pattern.

As shown in FIG. 15, a process of switching whether to generate the correction data according to the type of the recording medium ME0 may be performed. The recording medium setting process and the condition-based process shown in FIG. 15 are performed by the control section U1 shown in FIG. 1, for example, by the controller 10 shown in FIG. 1. In this case, when the input section 26 receives an operation from the user to start the recording medium setting process, the controller 10 causes the outputting section 25 to display a setting screen for the type of the recording medium ME0 on which the print image IM0 is to be formed, and receives the setting for the type of recording medium ME0 on which the print image IM0 is to be formed (S502). At least a part of the recording medium setting process may be performed in the host device HO1 shown in FIG. 1. In this case, when the host device HO1 receives an operation from the user for starting the recording medium setting process, the host device HO1 causes the display section to display the above-described setting screen and receives the setting for the type of the recording medium ME0 on which the print image IM0 is to be formed.

On plain paper indicated in FIG. 15, the ink is relatively more likely to spread, and a greater color shift due to the timing difference T of ink droplet ejection is more likely to appear. On the glossy paper shown in FIG. 15, the ink is relatively less likely to spread, and a smaller color shift due to the timing difference T of ink droplet ejection is relatively likely. It is presumed that this is because a large amount of the first color ink droplets 371 that landed first remains on the surface of the glossy paper, so that even if the second color ink droplets 372 land later, a large amount of the color of the first color ink droplets 371 remains. From another point of view, it is presumed that when the recording medium ME0 is plain paper, the color of the second color ink droplets 372 that lands later appears more intense because the first color ink droplets 371 that landed earlier had soaked into the plain paper. In the example shown in FIG. 15, plain paper is an example of the first recording medium ME1, and glossy paper is an example of the second recording medium ME2 in which the color shift due to the timing difference T is smaller than that of the first recording medium ME1.

After the process of S502, the controller 10 stores the setting for the type of the recording medium ME0 in the storage section 23 (S504), and ends the recording medium setting process. Needless to say, the host device HO1 may store the setting for the type of the recording medium ME0.

When the color conversion section 12 acquires the original image data DA1, the controller 10 starts the condition-based process and changes the process according to the type of the set recording medium ME0 (S512). When the set type of the recording medium ME0 corresponds to plain paper, the controller 10 performs the correction data generation process shown in FIG. 10 (S514) and ends the condition-based process. When the set type of the recording medium ME0 corresponds to glossy paper, the controller 10 ends the condition-based process without performing the process of S514. In the determination process of S210 in the print control process shown in FIG. 11, the controller 10 may determine both whether or not the set type of the recording medium ME0 corresponds to plain paper and whether or not the set print mode is a mode for performing color bidirectional band printing. The controller 10 forms the print image IM0 by compensating the color shift due to the timing difference T in S212 to S216 when the conditions are satisfied, and forms the print image IM0 in S216 without performing the process of compensating the color shift due to the timing difference T when the conditions are not satisfied.

Therefore, in a case where the type of the recording medium ME0 corresponds to the first recording medium ME1, the control section U1 forms the print image IM0 after causing the compensation section U2 to compensate for the color shift due to the timing difference T. On the other hand, when the type of the recording medium ME0 corresponds to the second recording medium ME2, the control section U1 does not perform the process of compensating for the color shift due to the timing difference T.

The determination process of S512 may be performed in the host device HO1 shown in FIG. 1. In this case, when the host device HO1 receives an operation from the user for printing the original image data DA1, the host device HO1 starts the condition-based process, and changes the process according to the type of the set recording medium ME0 (S512). When the set type of the recording medium ME0 corresponds to plain paper, the correction data generation process is performed (S514), and when the set type of the recording medium ME0 corresponds to glossy paper, the correction data generation process is not performed.

In the example shown in FIG. 15, when the color shift due to the timing difference T of ink droplet ejection is small, it is not necessary to perform the process of compensating for the color shift, and thus it is possible to improve convenience for the user.

### (5) Conclusion

As described above, according to various aspects of the present disclosure, it is possible to provide technology or the like capable of reducing color unevenness caused by a vertical array head. As a matter of course, the above-described basic operations and effects can be obtained even with a technology consisting only of the constituent elements according to the independent claims.

In addition, it is possible to implement a configuration in which each configuration disclosed in the above-described examples is replaced with each other or a combination thereof is changed, a configuration in which each configuration disclosed in a known technology and the above-described examples is replaced with each other or a combination thereof is changed, and the like. The present disclosure includes these configurations and the like.

What is claimed is:

1. A printing device comprising:
a recording head including a black nozzle row in which a plurality of black nozzles for ejecting black ink droplets are aligned and a plurality of color nozzle groups in which a plurality of color nozzles for ejecting color ink droplets are aligned along the black nozzle row, the color nozzle groups being aligned in order in an alignment direction of the plurality of black nozzles;
a drive section configured to perform main scanning in which a relative position between the recording head and the recording medium is changed in a forward path and a return path along a main scanning direction, which intersects the alignment direction, and to perform sub-scanning in which the relative position between the recording head and the recording medium is changed along a sub-scanning direction, which intersects the main scanning direction; and
a control section configured to control bidirectional printing in which color ink droplets are deposited on the recording medium in both the forward path and in the return path of one main scanning between sub-scannings, from the color nozzle groups allocated to band regions, which correspond to lengths in the sub-scanning direction of the color nozzle groups that eject the color ink droplets, wherein
the plurality of color nozzle groups includes a first color nozzle group and a second color nozzle group in which colors of the color ink droplets ejected to a band region in the forward path and in the return path in the bidirectional printing are different from each other,
the color ink droplets ejected by the first color nozzle group are referred to as first color ink droplets and the color ink droplets ejected by the second color nozzle group are referred to as second color ink droplets,
the control section includes a compensation section that compensates for a color shift due to a timing difference between ejection of the first color ink droplets and ejection of the second color ink droplets that occurs depending on a position in the main scanning direction in the band region, and
the compensation section is configured to
form a reference patch on the recording medium by ejecting the first color ink droplets and the second color ink droplets in a predetermined recording density ratio at a reference timing difference, which is a reference for the timing difference,
form a plurality of first patches on the recording medium by ejecting the first color ink droplets and the second color ink droplets in a plurality of different recording density ratios at a first timing difference that is different from the reference timing difference, and
form a print image after compensating for the color shift due to the timing difference, wherein the compensation is based on a recording density ratio that corresponds to a first color shift compensation patch that was selected from the plurality of first patches.

2. The printing device according to claim 1, wherein
the first timing difference is greater than the reference timing difference and
the compensation section is configured to
form a plurality of second patches on the recording medium by ejecting the first color ink droplets and the second color ink droplets in a plurality of different recording density ratios at a second timing difference smaller than the reference timing difference and
form the print image after compensating for the color shift due to the timing difference, wherein the compensation is based on the recording density ratio that corresponds to the first color shift and a recording density ratio corresponding to a second color shift compensation patch that was selected from the plurality of second patches.

3. The printing device according to claim 2, wherein
the compensation section forms, as the reference patch, a first reference patch disposed between the first patches and a second reference patch disposed between the second patches on the recording medium.

4. The printing device according to claim 1, wherein
the compensation section performs control such that ejections of the first color ink droplets and the second color ink droplets for forming the reference patch on the recording medium are aligned with either the forward path or the return path.

5. The printing device according to claim 2, wherein
the compensation section performs control such that ejections of the first color ink droplets and the second color ink droplets for forming the plurality of first patches and the plurality of second patches on the recording medium are aligned with either the forward path or the return path.

6. The printing device according to claim 2, wherein
the first timing difference is a maximum of the timing difference in the bidirectional printing and
the second timing difference is a minimum of the timing difference in the bidirectional printing.

7. The printing device according to claim 1, wherein
the recording medium includes a first recording medium and a second recording medium, the second recording medium having a smaller color shift due to the timing difference than does the first recording medium and
the control section is configured to
receive a setting of a type of the recording medium on which the print image is to be formed,
when the type corresponds to the first recording medium, form the print image after compensating, in the compensation section, for the color shift due to the timing difference, and
when the type corresponds to the second recording medium, not perform a process of compensating for the color shift due to the timing difference.

8. The printing device according to claim 1, wherein
the compensation section acquires reading results of the reference patch and the plurality of first patches and selects the first color shift compensation patch from the plurality of first patches based on the reading results.

9. A printing method for a printer, the printer including
a recording head including a black nozzle row in which a plurality of black nozzles ejecting black ink droplets are aligned and a plurality of color nozzle groups in which a plurality of color nozzles ejecting color ink droplets are aligned along the black nozzle row, the plurality of color nozzle groups being aligned in order in an alignment direction of the plurality of black nozzles and
a drive section configured to perform main scanning in which a relative position between the recording head and the recording medium is changed in a forward path and a return path along a main scanning direction, which intersects the alignment direction, and to perform sub-scanning in which the relative position between the recording head and the recording medium is changed along a sub-scanning direction, which intersects the main scanning direction, wherein
the printing method is for bidirectional printing in which color ink droplets are deposited on the recording medium in both the forward path and in the return path of one main scanning between sub-scannings, from the color nozzle groups allocated to band regions, which correspond to lengths in the sub-scanning direction of the color nozzle groups that eject the color ink droplets,
the plurality of color nozzle groups include a first color nozzle group and a second color nozzle group in which colors of the color ink droplets ejected to a band region in the forward path and in the return path in the bidirectional printing are different from each other, and
the color ink droplets ejected by the first color nozzle group are referred to as first color ink droplets, and the color ink droplets ejected by the second color nozzle group are referred to as second color ink droplets,
the printing method comprising:
a reference patch formation step of forming a reference patch on the recording medium by ejecting the first color ink droplets and the second color ink droplets in a predetermined recording density ratio at a reference timing difference, which is a reference of an ejection timing difference between the first color ink droplets and the second color ink droplets that occurs depending on a position in the main scanning direction in the band region;
a first patch formation step of forming a plurality of first patches on the recording medium by ejecting the first color ink droplets and the second color ink droplets in a plurality of different recording density ratios at a first timing difference, which is different from the reference timing difference; and
a print image formation step of forming a print image after compensating for the color shift due to the timing difference, wherein the compensation is based on a recording density ratio that corresponds to a first color shift compensation patch that was selected from the plurality of first patches.
